(19) United States
(12) Patent Application Publication
(10) Pub. No.: US 2020/0029096 A1
(43) Pub. Date: Jan. 23, 2020

(54) COMBINED INVERSE DYNAMIC RANGE ADJUSTMENT (DRA) AND LOOP FILTER TECHNIQUE

(71) Applicant: QUALCOMM Incorporated, San Diego, CA (US)

(72) Inventor: Dmytro RUSANOVSKYY, San Diego, CA (US)

(21) Appl. No.: 16/513,486

(22) Filed: Jul. 16, 2019

Related U.S. Application Data
(60) Provisional application No. 62/699,722, filed on Jul. 17, 2018.

(51) Int. Cl. H04N 19/82; H04N 19/98; H04N 19/587; H04N 19/159; H04N 19/52; H04N 19/176

(52) U.S. Cl. CPC H04N 19/82; H04N 19/98; H04N 19/176; H04N 19/159; H04N 19/52; H04N 19/587

(57) ABSTRACT

Systems and methods for processing video data receiving encoded video data including a plurality of pictures. One or more predicted video samples for a picture of the plurality of pictures are predicted based on application of a prediction mode to the picture. A combined inverse dynamic range adjustment (DRA) and loop filter function is applied to the one or more predicted video samples using a combination of one or more parameters of an inverse DRA with one or more parameters of a loop filter to generate one or more reconstructed samples for the picture. The one or more reconstructed samples for the picture are generated based on the application of the combined inverse DRA and loop filter function to the one or more predicted video samples using the combination of one or more parameters of the inverse DRA with the one or more parameters of the loop filter.

### CROSS-REFERENCE TO RELATED APPLICATIONS

This application claims the benefit of U.S. Provisional Application No. 62/699,722, filed Jul. 17, 2018, which is hereby incorporated by reference, in its entirety and for all purposes.

### FIELD

This application is related to video coding systems and methods. For example, aspects of this disclosure are directed to a combined inverse dynamic range adjustment (DRA) and loop filter technique.

### BACKGROUND

Many devices and systems allow video data to be processed and output for consumption. Digital video data includes large amounts of data to meet the demands of consumers and video providers. For example, consumers of video data desire video of the utmost quality, with high fidelity, resolutions, frame rates, and the like. As a result, the large amount of video data that is required to meet these demands places a burden on communication networks and devices that process and store the video data.

Various video coding techniques may be used to compress video data. Video coding is performed according to one or more video coding standards. For example, video coding standards include versatile video coding (VVC), high-efficiency video coding (HEVC), advanced video coding (AVC), moving picture experts group (MPEG) coding, among others. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality. With ever-evolving video services becoming available, encoding techniques with better coding efficiency are needed.

### SUMMARY

Techniques and systems are described herein for applying a combined inverse dynamic range adjustment (DRA) and loop filter function to process video data. According to some examples, a DRA may be implemented to linearize perceived distortion (e.g., in terms of signal to noise ratio) of encoded signals within a dynamical range. In some examples, applying the DRA can include a forward mapping which results in a corresponding redistribution of code words of video samples. To compensate for this redistribution and to convert the redistributed code words back to their original domain, an inverse DRA function can be applied. Implementing the inverse DRA function can involve processing resources such as power consumption, implementation costs, and processing delays.

In some examples, the processing resources associated with implementing the DRA function can be reduced. In some examples, reducing the processing resources associated with the inverse DRA function can include combining the inverse DRA function with one or more coding loop filters or in-loop filters such as deblocking filters, bilateral filters, sample adaptive offset (SAO) filters, interpolation filters, adaptive loop filters (ALFs), any combination thereof, and/or other coding loop or in-loop filters. In some examples, combining the inverse DRA function with a coding loop filter can involve a combined inverse DRA and loop filter function using combined parameters for the inverse DRA and the loop filter function.

According to at least one example, a method for processing video data is provided. The method includes receiving encoded video data including a plurality of pictures and predicting one or more predicted video samples for a picture of the plurality of pictures based on application of a prediction mode to the picture. The method further includes applying a combined inverse dynamic range adjustment (DRA) and loop filter function to the one or more predicted video samples using a combination of one or more parameters of an inverse DRA with one or more parameters of a loop filter to generate one or more reconstructed samples for the picture. The method further includes generating the one or more reconstructed samples for the picture based on the application of the combined inverse DRA and loop filter function to the one or more predicted video samples using the combination of one or more parameters of the inverse DRA with the one or more parameters of the loop filter.

In another example, an apparatus for processing video data is provided. The apparatus includes a memory and a processor implemented in circuitry. The apparatus is configured to and can receive encoded video data including a plurality of pictures. The apparatus is further configured to and can predict one or more predicted video samples for a picture of the plurality of pictures based on application of a prediction mode to the picture. The apparatus is further configured to and can apply a combined inverse dynamic range adjustment (DRA) and loop filter function to the one or more predicted video samples using a combination of one or more parameters of an inverse DRA with one or more parameters of a loop filter to generate one or more reconstructed samples for the picture. The apparatus is further configured to and can generate the one or more reconstructed samples for the picture based on the application of the combined inverse DRA and loop filter function to the one or more predicted video samples using the combination of one or more parameters of the inverse DRA with the one or more parameters of the loop filter.

In another example, a non-transitory computer-readable medium is provided that has stored thereon instructions that, when executed by one or more processors, cause the one or more processors to: receive encoded video data including a plurality of pictures; predict one or more predicted video samples for a picture of the plurality of pictures based on application of a prediction mode to the picture; apply a combined inverse dynamic range adjustment (DRA) and loop filter function to the one or more predicted video samples using a combination of one or more parameters of an inverse DRA with one or more parameters of a loop filter to generate one or more reconstructed samples for the picture; and generate the one or more reconstructed samples for the picture based on the application of the combined inverse DRA and loop filter function to the one or more predicted video samples using the combination of one or more parameters of the inverse DRA with the one or more parameters of the loop filter.

In another example, an apparatus for processing video data is provided. The apparatus includes: means for receiving encoded video data including a plurality of pictures; means for predicting one or more predicted video samples for a picture of the plurality of pictures based on application of a prediction mode to the picture; means for applying a combined inverse dynamic range adjustment (DRA) and loop filter function to the one or more predicted video samples using a combination of one or more parameters of an inverse DRA with one or more parameters of a loop filter to generate one or more reconstructed samples for the picture; and means for generating the one or more reconstructed samples for the picture based on the application of the combined inverse DRA and loop filter function to the one or more predicted video samples using the combination of one or more parameters of the inverse DRA with the one or more parameters of the loop filter.

In some aspects of the methods, apparatuses, and computer-readable medium described above, the one or more parameters of the inverse DRA include one or more inverse DRA scale values and one or more inverse DRA offset values, the one or more parameters of the loop filter include one or more loop filter scale values and one or more loop filter offset values, and the combination of the one or more parameters of the inverse DRA with the one or more parameters of the loop filter includes a combination of the one or more inverse DRA scale values with the one or more loop filter scale values, and a combination of the one or more inverse DRA offset values with the one or more loop filter offset values. In some aspects, the methods, apparatuses, and computer-readable medium described above further include a lookup table for storing the combination of the one or more parameters of the inverse DRA with the one or more parameters of the loop filter.

In some aspects of the methods, apparatuses, and computer-readable medium described above, the one or more parameters of the inverse DRA are obtained from an inverse DRA lookup table using the one or more predicted video samples.

In some aspects of the methods, apparatuses, and computer-readable medium described above, the one or more parameters of the loop filter are obtained from a loop filter lookup table using the one or more predicted video samples.

In some aspects of the methods, apparatuses, and computer-readable medium described above, the loop filter includes a bilateral filter.

In some aspects of the methods, apparatuses, and computer-readable medium described above, the loop filter includes an adaptive loop filter (ALF).

In some aspects of the methods, apparatuses, and computer-readable medium described above, the loop filter includes a sample adaptive offset (SAO) filter.

In some aspects of the methods, apparatuses, and computer-readable medium described above, the loop filter includes a deblocking filter.

In some aspects of the methods, apparatuses, and computer-readable medium described above, the loop filter includes two or more of a bilateral filter, an adaptive loop filter (ALF), a sample adaptive offset (SAO) filter, and a deblocking filter applied sequentially on the one or more predicted video samples.

In some aspects of the methods, apparatuses, and computer-readable medium described above, applying the combined inverse DRA and loop filter function includes applying a combination of one or more parameters of the inverse DRA with one or more parameters of one of the bilateral filter, the adaptive loop filter (ALF), the sample adaptive offset (SAO) filter, or the deblocking filter.

In some aspects, the methods, apparatuses, and computer-readable medium described above further include outputting the one or more reconstructed video samples.

In some aspects of the methods, apparatuses, and computer-readable medium described above, outputting the one or more reconstructed video samples includes storing a decoded version of the picture including the one or more reconstructed video samples in a decoded picture buffer.

In some aspects of the methods, apparatuses, and computer-readable medium described above, processing the video data is performed as part of a video decoding process.

In some aspects of the methods, apparatuses, and computer-readable medium described above, processing the video data is performed as part of a decoding loop of a video encoding process, and outputting the one or more reconstructed video samples includes storing a decoded version of the picture including the one or more reconstructed video samples as a reference picture for use in encoding at least one other picture of the video data.

In some aspects of the methods, apparatuses, and computer-readable medium described above, outputting the one or more reconstructed video samples includes outputting a decoded version of the picture including the one or more reconstructed video samples to a display device.

In some aspects of the methods, apparatuses, and computer-readable medium described above, the inverse DRA maps altered codewords of the one or more predicted video samples to the one or more reconstructed video samples, where the altered codewords are generated by a DRA applied to codewords of video data for reshaping the video data.

In some aspects of the methods, apparatuses, and computer-readable medium described above, the prediction mode includes an inter-prediction mode or an intra-prediction mode.

In some cases, one or more aspects of the methods, apparatuses, and computer-readable medium described above can be implemented by a video decoder. In some cases, one or more aspects of the methods, apparatuses, and computer-readable medium described above can be implemented by a video encoder.

Some aspects of the methods, apparatuses, and computer-readable medium described above include a display for displaying one or more reconstructed video samples.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative examples of the various implementations are described in detail below with reference to the following drawing figures:

FIG. 1 is a block diagram illustrating an example of a video coding system including an encoding device and a decoding device, in accordance with some examples;

FIG. 2 is a diagram illustrating various dynamic ranges of the human vision and various display types, in accordance with some examples;

FIG. 3 is a diagram illustrating an example of a chromaticity diagram, overlaid with a triangle representing an SDR color gamut and a triangle representing an high dynamic range (HDR) color gamut, in accordance with some examples;

FIG. 4 is a diagram illustrating an example of a process for performing HDR/wide color gamut (WCG) representation conversion, in accordance with some examples;

FIG. 5 is a diagram illustrating an example of a process for performing inverse HDR/WCG conversion, in accordance with some examples;

FIG. 6 is a graph illustrating examples of luminance curves produced by transfer functions defined by various standards, in accordance with some examples;

FIG. 7 is a graph illustrating an example of a perceptual quantizer (PQ) transfer function (ST2084 electro-optical transfer function (EOTF)), in accordance with some examples;

FIG. 8A-FIG. 8C are graphs which illustrate an example of a dynamic range adjustment (DRA) implementation, in accordance with some examples,

FIG. 9A-FIG. 9B are block diagrams illustrating examples of decoding devices which implement inverse DRA functions, in accordance with some examples;

FIG. 10 is a block diagram illustrating an example of a decoding device which implements an inverse DRA function, in accordance with some examples;

FIG. 11 is a block diagram which illustrates an example implementation of a bilateral filter, in accordance with some examples;

FIG. 12 is a block diagram which illustrates an example implementation of an adaptive loop filter (ALF), in accordance with some examples;

FIG. 13 is a block diagram which illustrates an example of a decoding device which implements a combined inverse DRA and loop filter (LF) function, in accordance with some examples;

FIG. 14 is a flowchart illustrating an example of a process of processing video data, in accordance with some examples;

FIG. 15 is a block diagram illustrating an example encoding device, in accordance with some examples; and

FIG. 16 is a block diagram illustrating an example decoding device, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Video coding devices implement video compression techniques to encode and decode video data efficiently. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data, and/or other prediction techniques to reduce or remove redundancy inherent in video sequences. A video encoder can partition each picture of an original video sequence into rectangular regions referred to as video blocks or coding units (described in greater detail below). These video blocks may be encoded using a particular prediction mode.

Video blocks may be divided in one or more ways into one or more groups of smaller blocks. Blocks can include coding tree blocks, prediction blocks, transform blocks, and/or other suitable blocks. References generally to a “block,” unless otherwise specified, may refer to such video blocks (e.g., coding tree blocks, coding blocks, prediction blocks, transform blocks, or other appropriate blocks or sub-blocks, as would be understood by one of ordinary skill). Further, each of these blocks may also interchangeably be referred to herein as “units” (e.g., coding tree unit (CTU), coding unit, prediction unit (PU), transform unit (TU), or the like). In some cases, a unit may indicate a coding logical unit that is encoded in a bitstream, while a block may indicate a portion of video frame buffer a process is target to.

For inter-prediction modes, a video encoder can search for a block similar to the block being encoded in a frame (or picture) located in another temporal location, referred to as a reference frame or a reference picture. The video encoder may restrict the search to a certain spatial displacement from the block to be encoded. A best match may be located using a two-dimensional (2D) motion vector that includes a horizontal displacement component and a vertical displacement component. For intra-prediction modes, a video encoder may form the predicted block using spatial prediction techniques based on data from previously encoded neighboring blocks within the same picture.

The video encoder may determine a prediction error. For example, the prediction can be determined as the difference between the pixel values in the block being encoded and the predicted block. The prediction error can also be referred to as the residual. The video encoder may also apply a transform to the prediction error (e.g., a discrete cosine transform (DCT) or other suitable transform) to generate transform coefficients. After transformation, the video encoder may quantize the transform coefficients. The quantized transform coefficients and motion vectors may be represented using syntax elements, and, along with control information, form a coded representation of a video sequence. In some instances, the video encoder may entropy code syntax elements, thereby further reducing the number of bits needed for their representation.

A video decoder may, using the syntax elements and control information discussed above, construct predictive data (e.g., a predictive block) for decoding a current frame. For example, the video decoder may add the predicted block and the compressed prediction error. The video decoder may determine the compressed prediction error by weighting the transform basis functions using the quantized coefficients. The difference between the reconstructed frame and the original frame is called reconstruction error.

The techniques described herein can be applied to any of the existing video codecs (e.g., High Efficiency Video Coding (HEVC), Advanced Video Coding (AVC), or other suitable existing video codec), and/or can be an efficient coding tool for any video coding standards being developed and/or future video coding standards, such as, for example, Versatile Video Coding (VVC), the joint exploration model (JEM), and/or other video coding standard in development or to be developed.

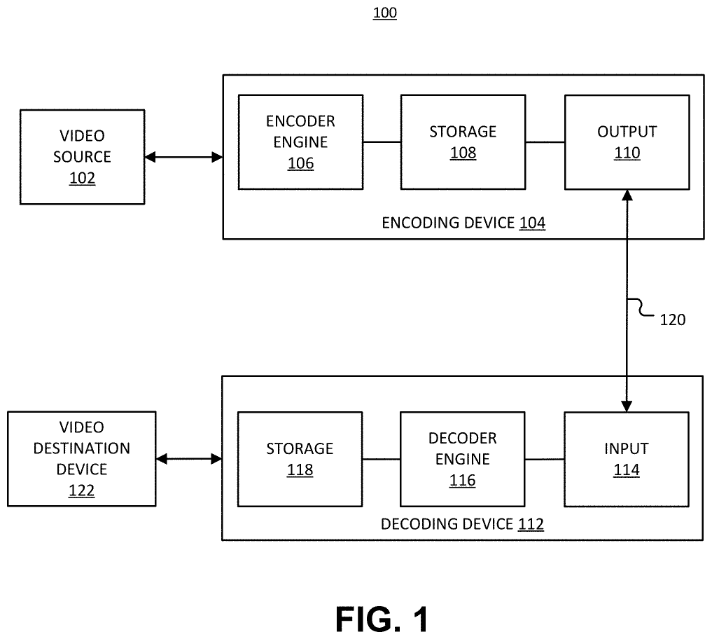

FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. In some examples, system 100 can support one-way or two-way video transmission to support applications such as video conferencing, video streaming, video playback, video broadcasting, gaming, and/or video telephony.

The encoding device 104 (or encoder) can be used to encode video data using a video coding standard or protocol to generate an encoded video bitstream. Examples of video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), including its Scalable Video Coding (SVC) and Multiview Video Coding (MVC) extensions, and High Efficiency Video Coding (HEVC) or ITU-T H.265. Various extensions to HEVC deal with multi-layer video coding exist, including the range and screen content coding extensions, 3D video coding (3D-HEVC) and multiview extensions (MV-HEVC) and scalable extension (SHVC). The HEVC and its extensions have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

MPEG and ITU-T VCEG have also formed a joint exploration video team (JVET) to explore and develop new video coding tools for the next generation of video coding standard, named Versatile Video Coding (VVC). The reference software is called VVC Test Model (VTM). An objective of VVC is to provide a significant improvement in compression performance over the existing HEVC standard, aiding in deployment of higher-quality video services and emerging applications (e.g., such as 360° omnidirectional immersive multimedia, high-dynamic-range (HDR) video, among others).

Many embodiments described herein provide examples using the VTM, VVC, HEVC, and/or extensions thereof. However, the techniques and systems described herein may also be applicable to other coding standards, such as AVC, MPEG, JPEG (or other coding standard for still images), extensions thereof, or other suitable coding standards already available or not yet available or developed. Accordingly, while the techniques and systems described herein may be described with reference to a particular video coding standard, one of ordinary skill in the art will appreciate that the description should not be interpreted to apply only to that particular standard.

Referring to FIG. 1, a video source 102 may provide the video data to the encoding device 104. The video source 102 may be part of the source device, or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures. Pictures may also be referred to as “frames.” A picture or frame is a still image that, in some cases, is part of a video. In some examples, data from the video source 102 can be a still image that is not a part of a video. In HEVC, VVC, and other video coding specifications, a video sequence can include a series of pictures. A picture may include three sample arrays, denoted S_{L}, S_{Cb}, and S_{Cr}. S_{L} is a two-dimensional array of luma samples, S_{Cb} is a two-dimensional array of Cb chrominance samples, and S_{Cr} is a two-dimensional array of Cr chrominance samples. Chrominance samples may also be referred to herein as “chroma” samples. In other instances, a picture may be monochrome and may only include an array of luma samples.

The encoder engine 106 (or encoder) of the encoding device 104 encodes the video data to generate an encoded video bitstream. In some examples, an encoded video bitstream (or “video bitstream” or “bitstream”) is a series of one or more coded video sequences. A coded video sequence (CVS) includes a series of access units (AUs) starting with an AU that has a random access point picture in the base layer and with certain properties up to and not including a next AU that has a random access point picture in the base layer and with certain properties. For example, the certain properties of a random access point picture that starts a CVS may include a random-access skipped leading (RASL) flag (e.g., NoRaslOutputFlag) equal to 1. Otherwise, a random access point picture (with RASL flag equal to 0) does not start a CVS. An access unit (AU) includes one or more coded pictures and control information corresponding to the coded pictures that share the same output time. Coded slices of pictures are encapsulated in the bitstream level into data units called network abstraction layer (NAL) units. For example, an HEVC video bitstream may include one or more CVSs including NAL units. Each of the NAL units has a NAL unit header. In one example, the header is one-byte for H.264/AVC (except for multi-layer extensions) and two-byte for HEVC. The syntax elements in the NAL unit header take the designated bits and therefore are visible to all kinds of systems and transport layers, such as Transport Stream, Real-time Transport (RTP) Protocol, File Format, among others.

Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. In some cases, a NAL unit can be referred to as a packet. An HEVC AU includes VCL NAL units containing coded picture data and non-VCL NAL units (if any) corresponding to the coded picture data.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments.

In HEVC, the slices are then partitioned into coding tree blocks (CTBs) of luma samples and chroma samples. A CTB of luma samples and one or more CTBs of chroma samples, along with syntax for the samples, are referred to as a coding tree unit (CTU). A CTU may also be referred to as a “tree block” or a “largest coding unit” (LCU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma component or a chroma component that uses the same motion parameters for inter-prediction or intra-block copy prediction (when available or enabled for use). The luma PB and one or more chroma PBs, together with associated syntax, form a prediction unit (PU). For inter-prediction, a set of motion parameters (e.g., one or more motion vectors, reference indices, or the like) is signaled in the bitstream for each PU and is used for inter-prediction of the luma PB and the one or more chroma PBs. The motion parameters can also be referred to as motion information. A CB can also be partitioned into one or more transform blocks (TBs). A TB represents a square block of samples of a color component on which the same two-dimensional transform is applied for coding a prediction residual signal. A transform unit (TU) represents the TBs of luma and chroma samples, and corresponding syntax elements.

A size of a CU corresponds to a size of the coding mode and may be square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some embodiments, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may then be quantized by the encoder engine 106.

Once the pictures of the video data are partitioned into CUs, the encoder engine 106 predicts each PU using a prediction mode. The prediction unit or prediction block is then subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Intra-prediction utilizes the correlation between spatially neighboring samples within a picture. For example, using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Inter-prediction uses the temporal correlation between pictures in order to derive a motion-compensated prediction for a block of image samples. For example, using inter-prediction, each PU is predicted using motion compensation prediction from image data in one or more reference pictures (before or after the current picture in output order). The decision whether to code a picture area using inter-picture or intra-picture prediction may be made, for example, at the CU level.

The encoder engine 106 and decoder engine 116 (described in more detail below) may be configured to operate according to VVC. According to VVC, a video coder (such as encoder engine 106 and/or decoder engine 116) partitions a picture into a plurality of coding tree units (CTUs). The video coder can partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels, including a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree partition, a binary tree partition, and one or more types of triple tree partitions. A triple tree partition is a partition where a block is split into three sub-blocks. In some examples, a triple tree partition divides a block into three sub-blocks without dividing the original block through the center. The partitioning types in MTT (e.g., quadtree, binary tree, and tripe tree) may be symmetrical or asymmetrical.

In some examples, the video coder can use a single QTBT or MTT structure to represent each of the luminance and chrominance components, while in other examples, the video coder can use two or more QTBT or MTT structures, such as one QTBT or MTT structure for the luminance component and another QTBT or MTT structure for both chrominance components (or two QTBT and/or MTT structures for respective chrominance components).

The video coder can be configured to use quadtree partitioning per HEVC, QTBT partitioning, MTT partitioning, or other partitioning structures. For illustrative purposes, the description herein may refer to QTBT partitioning. However, it should be understood that the techniques of this disclosure may also be applied to video coders configured to use quadtree partitioning, or other types of partitioning as well.

In VVC, a picture can be partitioned into slices, tiles, and bricks. In general, a brick can be a rectangular region of CTU rows within a particular tile in a picture. A tile can be a rectangular region of CTUs within a particular tile column and a particular tile row in a picture. A tile column is a rectangular region of CTUs having a height equal to the height of the picture and a width specified by syntax elements in the picture parameter set. A tile row is a rectangular region of CTUs having a height specified by syntax elements in the picture parameter set and a width equal to the width of the picture. In some cases, a tile may be partitioned into multiple bricks, each of which can include one or more CTU rows within the tile. A tile that is not partitioned into multiple bricks is also referred to as a brick. However, a brick that is a true subset of a tile is not referred to as a tile. A slice can be an integer number of bricks of a picture that are exclusively contained in a single NAL unit. In some cases, a slice can include either a number of complete tiles or only a consecutive sequence of complete bricks of one tile.

In some examples, the one or more slices of a picture are assigned a slice type. Slice types include an I slice, a P slice, and a B slice. An I slice (intra-frames, independently decodable) is a slice of a picture that is only coded by intra-prediction, and therefore is independently decodable since the I slice requires only the data within the frame to predict any prediction unit or prediction block of the slice. A P slice (uni-directional predicted frames) is a slice of a picture that may be coded with intra-prediction and with uni-directional inter-prediction. Each prediction unit or prediction block within a P slice is either coded with Intra prediction or inter-prediction. When the inter-prediction applies, the prediction unit or prediction block is only predicted by one reference picture, and therefore reference samples are only from one reference region of one frame. A B slice (bi-directional predictive frames) is a slice of a picture that may be coded with intra-prediction and with inter-prediction (e.g., either bi-prediction or uni-prediction). A prediction unit or prediction block of a B slice may be bi-directionally predicted from two reference pictures, where each picture contributes one reference region and sample sets of the two reference regions are weighted (e.g., with equal weights or with different weights) to produce the prediction signal of the bi-directional predicted block. As explained above, slices of one picture are independently coded. In some cases, a picture can be coded as just one slice.

As noted above, intra-picture prediction utilizes the correlation between spatially neighboring samples within a picture. Inter-picture prediction uses the temporal correlation between pictures in order to derive a motion-compensated prediction for a block of image samples. Using a translational motion model, the position of a block in a previously decoded picture (a reference picture) is indicated by a motion vector (Δx, Δy), with Δx specifying the horizontal displacement and Δy specifying the vertical displacement of the reference block relative to the position of the current block. In some cases, a motion vector (Δx, Δy) can be in integer sample accuracy (also referred to as integer accuracy), in which case the motion vector points to the integer-pel grid (or integer-pixel sampling grid) of the reference frame. In some cases, a motion vector (Δx, Δy) can be of fractional sample accuracy (also referred to as fractional-pel accuracy or non-integer accuracy) to more accurately capture the movement of the underlying object, without being restricted to the integer-pel grid of the reference frame. Accuracy of motion vectors may be expressed by the quantization level of the motion vectors. For example, the quantization level may be integer accuracy (e.g., 1-pixel) or fractional-pel accuracy (e.g., ¼-pixel, ½-pixel, or other sub-pixel value). Interpolation is applied on reference pictures to derive the prediction signal when the corresponding motion vector has fractional sample accuracy. For example, samples available at integer positions can be filtered (e.g., using one or more interpolation filters) to estimate values at fractional positions. The previously decoded reference picture is indicated by a reference index (refIdx) to a reference picture list. The motion vectors and reference indices can be referred to as motion parameters. Two kinds of inter-picture prediction can be performed, including uni-prediction and bi-prediction.

With inter-prediction using bi-prediction, two sets of motion parameters (Δx₀, y₀, refIdx₀ and Δx₁, y₁, refIdx₁) are used to generate two motion compensated predictions (from the same reference picture or possibly from different reference pictures). For example, with bi-prediction, each prediction block uses two motion compensated prediction signals, and generates B prediction units. The two motion compensated predictions are then combined to get the final motion compensated prediction. For example, the two motion compensated predictions can be combined by averaging. In another example, weighted prediction can be used, in which case different weights can be applied to each motion compensated prediction. The reference pictures that can be used in bi-prediction are stored in two separate lists, denoted as list 0 and list 1. Motion parameters can be derived at the encoder using a motion estimation process.

With inter-prediction using uni-prediction, one set of motion parameters (Δx₀, y₀, refIdx₀) is used to generate a motion compensated prediction from a reference picture. For example, with uni-prediction, each prediction block uses at most one motion compensated prediction signal, and generates P prediction units.

A PU may include the data (e.g., motion parameters or other suitable data) related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector (Δx), a vertical component of the motion vector (Δy), a resolution for the motion vector (e.g., integer precision, one-quarter pixel precision or one-eighth pixel precision), a reference picture to which the motion vector points, a reference index, a reference picture list (e.g., List 0, List 1, or List C) for the motion vector, or any combination thereof.

The encoding device 104 may then perform transformation and quantization. For example, following prediction, the encoder engine 106 may calculate residual values corresponding to the PU. Residual values may comprise pixel difference values between the current block of pixels being coded (the PU) and the prediction block used to predict the current block (e.g., the predicted version of the current block). For example, after generating a prediction block (e.g., using inter-prediction or intra-prediction), the encoder engine 106 can generate a residual block by subtracting the prediction block produced by a prediction unit from the current block. The residual block includes a set of pixel difference values that quantify differences between pixel values of the current block and pixel values of the prediction block. In some examples, the residual block may be represented in a two-dimensional block format (e.g., a two-dimensional matrix or array of pixel values). In such examples, the residual block is a two-dimensional representation of the pixel values.

Any residual data that may be remaining after prediction is performed is transformed using a block transform, which may be based on discrete cosine transform, discrete sine transform, an integer transform, a wavelet transform, other suitable transform function, or any combination thereof. In some cases, one or more block transforms (e.g., sizes 32×32, 16×16, 8×8, 4×4, or other suitable size) may be applied to residual data in each CU. In some embodiments, a TU may be used for the transform and quantization processes implemented by the encoder engine 106. A given CU having one or more PUs may also include one or more TUs. As described in further detail below, the residual values may be transformed into transform coefficients using the block transforms, and then may be quantized and scanned using TUs to produce serialized transform coefficients for entropy coding.

In some embodiments following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. Encoder engine 106 may form the TUs including the residual data for the CU, and may then transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded video bitstream includes quantized transform coefficients, prediction information (e.g., prediction modes, motion vectors, block vectors, or the like), partitioning information, and any other suitable data, such as other syntax data. The different elements of the coded video bitstream may then be entropy encoded by the encoder engine 106. In some examples, the encoder engine 106 may utilize a predefined scan order to scan the quantized transform coefficients to produce a serialized vector that can be entropy encoded. In some examples, encoder engine 106 may perform an adaptive scan. After scanning the quantized transform coefficients to form a vector (e.g., a one-dimensional vector), the encoder engine 106 may entropy encode the vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

The output 110 of the encoding device 104 may send the NAL units making up the encoded video bitstream data over the communications link 120 to the decoding device 112 of the receiving device. The input 114 of the decoding device 112 may receive the NAL units. The communications link 120 may include a channel provided by a wireless network, a wired network, or a combination of a wired and wireless network. A wireless network may include any wireless interface or combination of wireless interfaces and may include any suitable wireless network (e.g., the Internet or other wide area network, a packet-based network, WiFi™, radio frequency (RF), UWB, WiFi-Direct, cellular, Long-Term Evolution (LTE), WiMax™, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video bitstream data may be modulated according to a communication standard, such as a wireless communication protocol, and transmitted to the receiving device.

In some examples, the encoding device 104 may store encoded video bitstream data in storage 108. The output 110 may retrieve the encoded video bitstream data from the encoder engine 106 or from the storage 108. Storage 108 may include any of a variety of distributed or locally accessed data storage media. For example, the storage 108 may include a hard drive, a storage disc, flash memory, volatile or non-volatile memory, or any other suitable digital storage media for storing encoded video data.

The input 114 of the decoding device 112 receives the encoded video bitstream data and may provide the video bitstream data to the decoder engine 116, or to storage 118 for later use by the decoder engine 116. The decoder engine 116 may decode the encoded video bitstream data by entropy decoding (e.g., using an entropy decoder) and extracting the elements of one or more coded video sequences making up the encoded video data. The decoder engine 116 may then rescale and perform an inverse transform on the encoded video bitstream data. Residual data is then passed to a prediction stage of the decoder engine 116. The decoder engine 116 then predicts a block of pixels (e.g., a PU). In some examples, the prediction is added to the output of the inverse transform (the residual data).

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

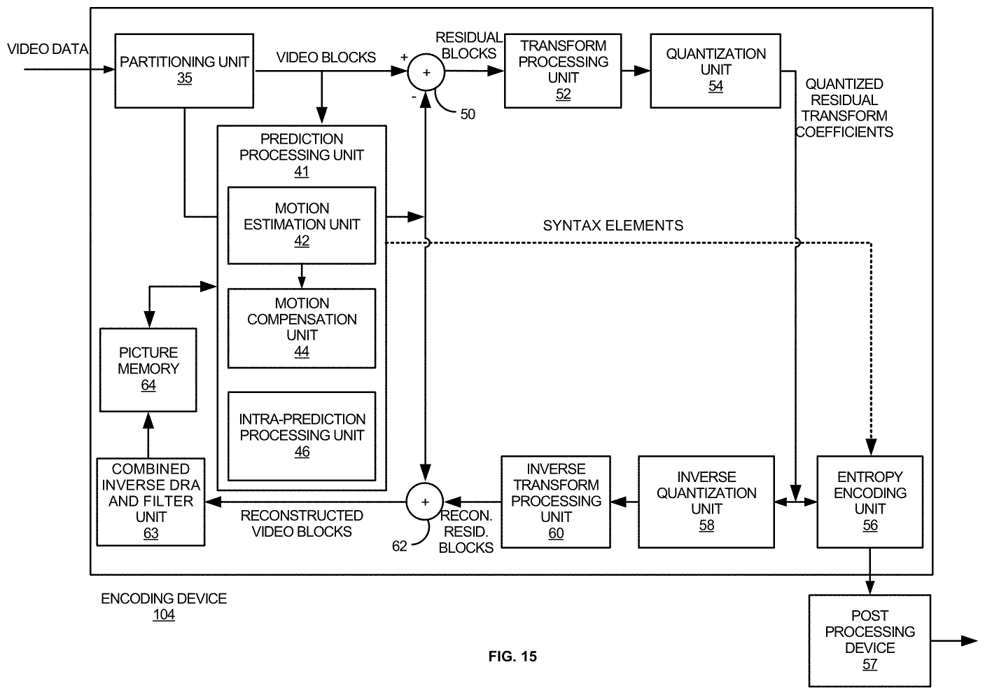

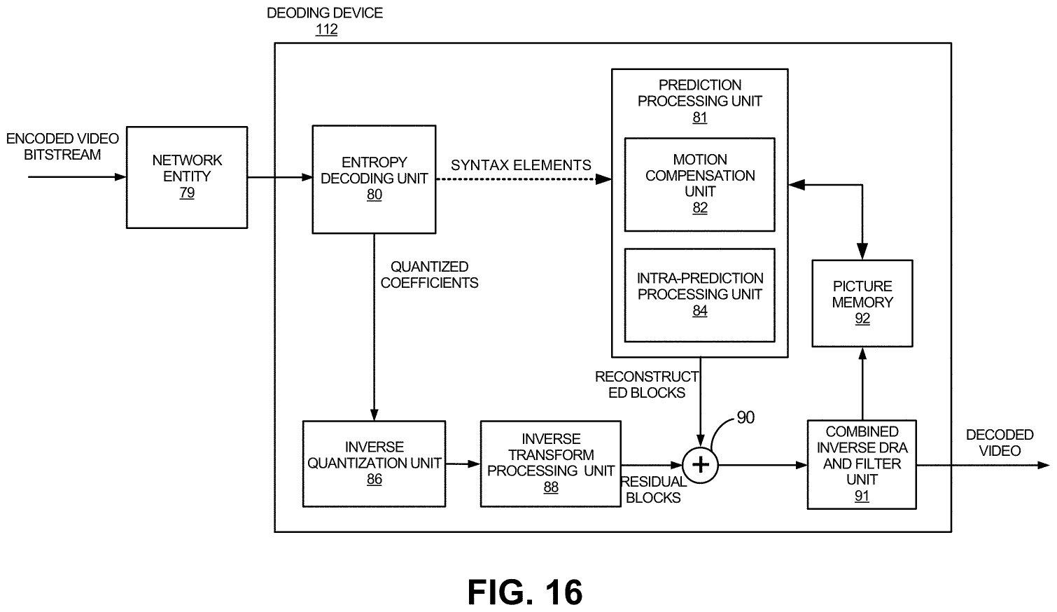

In some embodiments, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device. An example of specific details of the encoding device 104 is described below with reference to FIG. 15. An example of specific details of the decoding device 112 is described below with reference to FIG. 16.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers can represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

In general, a layer includes a set of VCL NAL units and a corresponding set of non-VCL NAL units. The NAL units are assigned a particular layer ID value. Layers can be hierarchical in the sense that a layer may depend on a lower layer. A layer set refers to a set of layers represented within a bitstream that are self-contained, meaning that the layers within a layer set can depend on other layers in the layer set in the decoding process, but do not depend on any other layers for decoding. Accordingly, the layers in a layer set can form an independent bitstream that can represent video content. The set of layers in a layer set may be obtained from another bitstream by operation of a sub-bitstream extraction process. A layer set may correspond to the set of layers that is to be decoded when a decoder wants to operate according to certain parameters.

As previously described, an HEVC bitstream includes a group of NAL units, including VCL NAL units and non-VCL NAL units. VCL NAL units include coded picture data forming a coded video bitstream. For example, a sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). Examples of goals of the parameter sets include bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. Because of this, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some embodiments, the VPS, SPS, or PPS may be transmitted in-band with the encoded bitstream. In some embodiments, the VPS, SPS, or PPS may be transmitted out-of-band in a separate transmission than the NAL units containing coded video data.

A video bitstream can also include Supplemental Enhancement Information (SEI) messages. For example, an SEI NAL unit can be part of the video bitstream. In some cases, an SEI message can contain information that is not needed by the decoding process. For example, the information in an SEI message may not be essential for the decoder to decode the video pictures of the bitstream, but the decoder can be use the information to improve the display or processing of the pictures (e.g., the decoded output). The information in an SEI message can be embedded metadata. In one illustrative example, the information in an SEI message could be used by decoder-side entities to improve the viewability of the content. In some instances, certain application standards may mandate the presence of such SEI messages in the bitstream so that the improvement in quality can be brought to all devices that conform to the application standard (e.g., the carriage of the frame-packing SEI message for frame-compatible plano-stereoscopic 3DTV video format, where the SEI message is carried for every frame of the video, handling of a recovery point SEI message, use of pan-scan scan rectangle SEI message in DVB, in addition to many other examples).

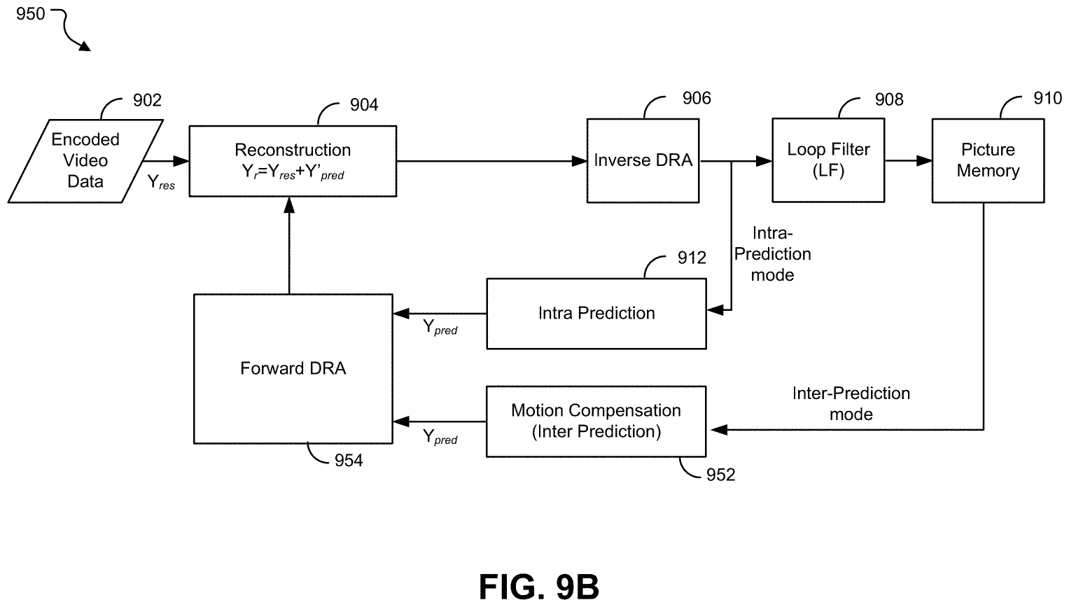

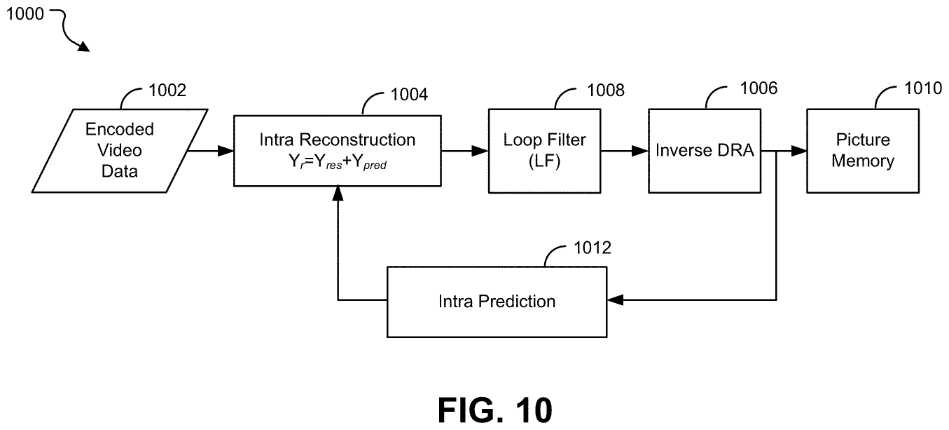

In some examples, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device. An example of specific details of the encoding device 104 is described below with reference to FIG. 10. An example of specific details of the decoding device 112 is described below with reference to FIG. 11.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers usually represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

Various standards have also been defined that describe the colors in a captured video, including the contrast ratio (e.g., the brightness or darkness of pixels in the video) and the color accuracy, among other things. Color parameters can be used, for example, by a display device that is able to use the color parameters to determine how to display the pixels in the video. One example standard from the International Telecommunication Union (ITU), ITU-R Recommendation BT.709 (referred to herein as “BT.709”), defines a standard for High-Definition Television (HDTV). Color parameters defined by BT.709 are usually referred to as Standard Dynamic Range (SDR) and standard color gamut. Another example standard is ITU-R Recommendation BT.2020 (referred to herein as “BT.2020”), which defines a standard for Ultra-High-Definition Television (UHDTV). The color parameters defined by BT.2020 are commonly referred to as High Dynamic Range (HDR) and Wide Color Gamut (WCG). Dynamic range and color gamut are referred to herein collectively as color volume.

Next generation video applications are anticipated to operate with video data representing captured scenery with HDR and WCG. Parameters of the utilized dynamic range and color gamut are two independent attributes of video content, and their specification for purposes of digital television and multimedia services are defined by several international standards. For example, as noted above, BT.709 defines parameters for HDTV, such as SDR and standard color gamut, and BT. 2020 specifies UHDTV parameters such as HDR and wide color gamut. There are also other SDOs documents specifying these attributes in other systems, e.g. P3 color gamut is defined in SMPTE-231-2 and some parameters of HDR are defined STMPTE-2084.

Dynamic range can be defined as the ratio between the minimum and maximum brightness of a video signal. Dynamic range can also be measured in terms of f-stops. For instance, in cameras, an f-stop is the ratio of the focal length of a lens to the diameter of camera's aperture. One f-stop can correspond to a doubling of the dynamic range of a video signal. As an example, MPEG defines HDR content as content that features brightness variations of more than 16 f-stops. In some examples, a dynamic range between 10 to 16 f-stops is considered an intermediate dynamic range, though in other examples this is considered an HDR dynamic range. The human visual system is capable for perceiving much larger dynamic range, however it includes an adaptation mechanism to narrow the simultaneous range.

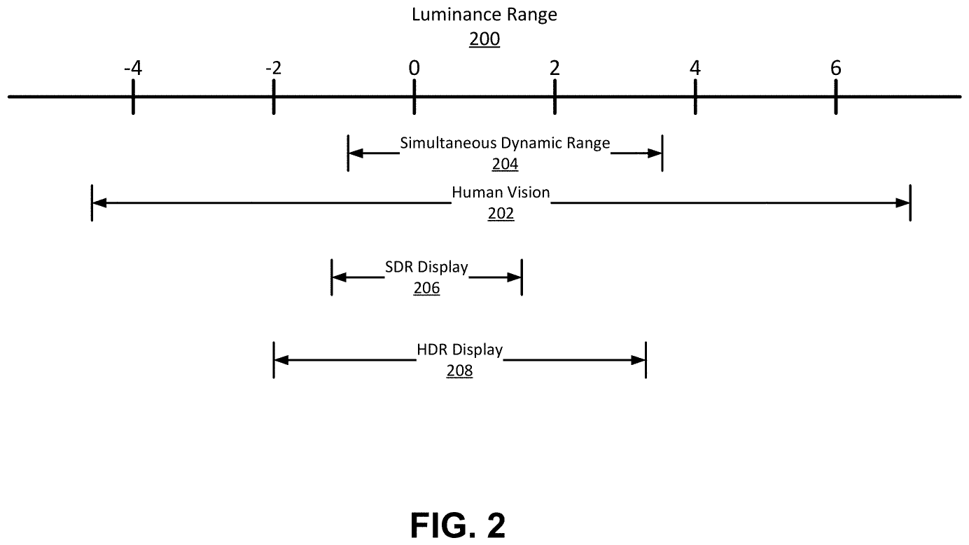

FIG. 2 illustrates the dynamic range of typical human vision 202, in comparison with the dynamic range of various display types. FIG. 2 illustrates a luminance range 200, in a nits log scale (e.g., in cd/m² logarithmic scale). By way of example, starlight is at approximately 0.0001 nits on the illustrated luminance range 200, and moonlight is at about 0.01 nits. Typical indoor light may be between 1 and 100 on the luminance range 200. Sunlight may be between 10,000 nits and 1,000,000 nits on the luminance range 200.

Human vision 202 is capable of perceiving anywhere between less than 0.0001 nits to greater than 1,000,000 nits, with the precise range varying from person to person. The dynamic range of human vision 202 includes a simultaneous dynamic range 204. The simultaneous dynamic range 204 is defined as the ratio between the highest and lowest luminance values at which objects can be detected, while the eye is at full adaption. Full adaptation occurs when the eye is at a steady state after having adjusted to a current ambient light condition or luminance level. Though the simultaneous dynamic range 204 is illustrated in the example of FIG. 2 as between about 0.1 nits and about 3200 nits, the simultaneous dynamic range 204 can be centered at other points along the luminance range 200 and the width can vary at different luminance levels. Additionally, the simultaneous dynamic range 204 can vary from one person to another.

FIG. 2 further illustrates an approximate dynamic range for SDR displays 206 and HDR display 208. SDR displays 206 include monitors, televisions, tablet screens, smart phone screens, and other display devices that are capable of displaying SDR video HDR displays 208 include, for example, ultra-high-definition televisions and other televisions and monitors.

BT.709 provides that the dynamic range of SDR displays 206 can be about 0.1 to 100 nits, or about 10 f-stops, which is significantly less than the dynamic range of human vision 202. The dynamic range of SDR displays 206 is also less than the illustrated simultaneous dynamic range 204. Some video application and services are regulated by Rec.709 and provide SDR, typically supporting a range of brightness (or luminance) of around 0.1 to 100 nits. SDR displays 206 are also unable to accurately reproduce night time conditions (e.g., starlight, at about 0.0001 nits) or bright outdoor conditions (e.g., around 1,000,000 nits).

Next generation video services are expected to provide dynamic range of up-to 16 f-stops. HDR displays 208 can cover a wider dynamic range than can SDR displays 206. For example, HDR displays 208 may have a dynamic range of about 0.01 nits to about 5600 nits (or 16 f-stops). While HDR displays 208 also do not encompass the dynamic range of human vision, HDR displays 208 may come closer to being able to cover the simultaneous dynamic range 204 of the average person. Specifications for dynamic range parameters for HDR displays 208 can be found, for example, in BT.2020 and ST 2084.

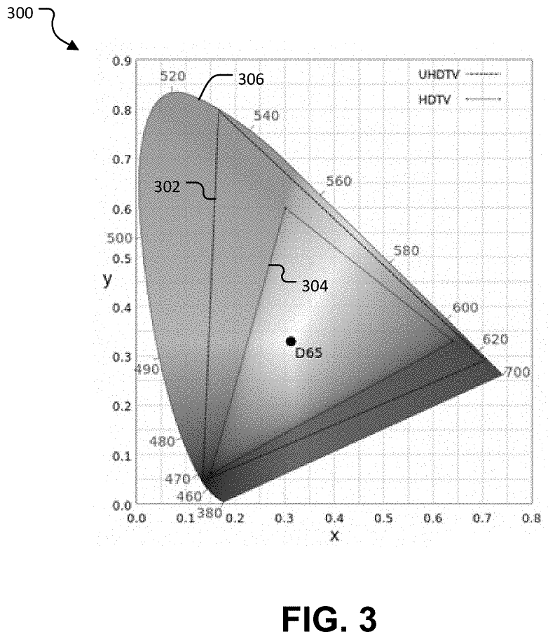

Color gamut describes the range of colors that are available on a particular device, such as a display or a printer. Color gamut can also be referred to as color dimension. FIG. 3 illustrates an example of a chromaticity diagram 300, overlaid with a triangle representing an SDR color gamut 304 and a triangle representing an HDR color gamut 302. Values on the curve 306 in the diagram 300 are the spectrum of colors; that is, the colors evoked by a wavelength of light in the visible spectrum. The colors below the curve 306 are non-spectral: the straight line between the lower points of the curve 306 is referred to as the line of purples, and the colors within the interior of the diagram 300 are unsaturated colors that are various mixtures of a spectral color or a purple color with white. A point labeled D65 indicates the location of white for the illustrated spectral curve 306. The curve 306 can also be referred to as the spectrum locus or spectral locus, representing limits of the natural colors.

The triangle representing an SDR color gamut 304 is based on the red, green, and blue color primaries as provided by BT.709. The SDR color gamut 304 is the color space used by HDTVs, SDR broadcasts, and other digital media content.

The triangle representing the wide HDR color gamut 302 is based on the red, green, and blue color primaries as provided by BT.2020. As illustrated by FIG. 3, the HDR color gamut 302 provides about 70% more colors than the SDR color gamut 304. Color gamuts defined by other standards, such as Digital Cinema Initiatives (DCI) P3 (referred to as DCI-P3) provide even more colors than the HDR color gamut 302. DCI-P3 is used for digital move projection.

Table 1 illustrates examples of colorimetry parameters for selected color spaces, including those provided by BT.709, BT.2020, and DCI-P3. For each color space, Table 1 provides an x and a y coordinate for a chromaticity diagram.

TABLE 1
Colorimetry parameters for selected color spaces

| Color | White Point | | Primary Colors | | | | | |
|---|---|---|---|---|---|---|---|---|
| Space | x_{w} | y_{w} | xᵣ | yᵣ | x_{g} | y_{g} | x_{b} | y_{b} |
| DCI-P3 | 0.314 | 0.351 | 0.68 | 0.32 | 0.265 | 0.69 | 0.15 | 0.06 |
| BT.709 | 0.3127 | 0.329 | 0.64 | 0.33 | 0.3 | 0.6 | 0.15 | 0.06 |
| BT.2020 | 0.3127 | 0.329 | 0.708 | 0.292 | 0.170 | 0.797 | 0.131 | 0.046 |

Video data with a large color volume (e.g., video data with a high dynamic range and wide color gamut) can be acquired and stored with a high degree of precision per component. For example, floating point values can be used to represent the luma and chroma values of each pixel. As a further example, 4:4:4 chroma format, where the luma, chroma-blue, and chroma-red components each have the same sample rate, may be used. The 4:4:4 notation can also be used to refer to the Red-Green-Blue (RGB) color format. As a further example, a very wide color space, such as that defined by International Commission on Illumination (CIE) 1931 XYZ, may be used. Video data represented with a high degree of precision may be nearly mathematically lossless. A high-precision representation, however, may include redundancies and may not be optimal for compression. Thus, a lower-precision format that aims to display the color volume that can be seen by the human eye is often used.

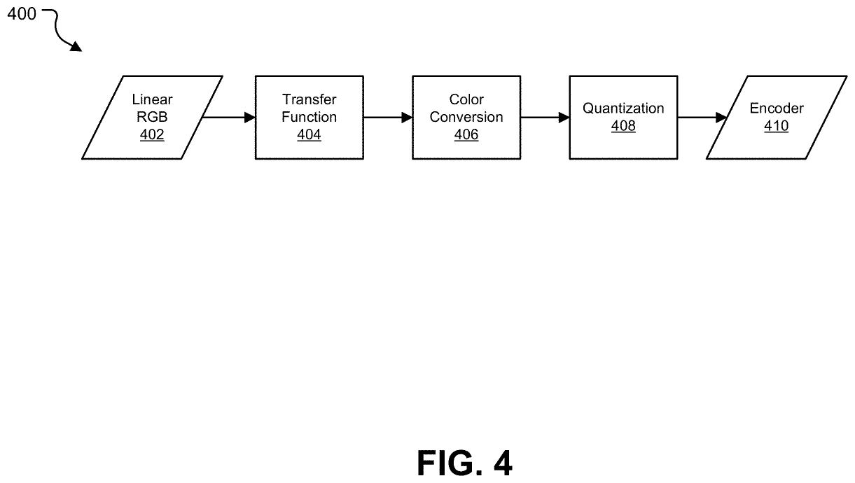

FIG. 4 illustrates an example of a process 400 for performing HDR video data format conversion for purposes of compression. The HDR data may have a lower precision and may be more easily compressed. The example process 400 includes a non-linear transfer function 404, which can compact the dynamic range, a color conversion 406 that can produce a more compact or robust color space, and a quantization 408 function that can convert floating point representations to integer representations (quantization).

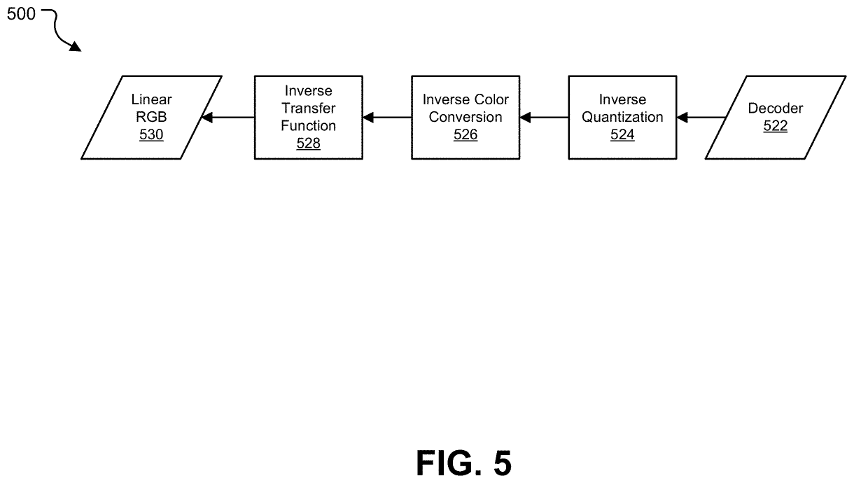

FIG. 5 illustrates an example of a process 500 for performing an inverse conversion for HDR video data at a decoder 522. The example process 500 performs inverse quantization 524 (e.g., for converting integer representations to floating point representations), an inverse color conversion 526, and an inverse transfer function 528 function.

In various examples, the high dynamic range of input RGB data in linear and floating point representation can be compacted using the non-linear transfer function 404. An illustrative example of a non-linear transfer function 404 is the perceptual quantizer defined in ST 2084. The output of the transfer function 404 can be converted to a target color space by the color conversion 406. The target color space can be one (e.g., YCbCr) that is more suitable for compression by the encoder 410. Quantization 408 can then be used to convert the data to an integer representation.

The order of the steps of the example processes 400 and 500 are illustrative examples of the order in which the steps can be performed. In other examples, the steps can occur in a different order. For example, the color conversion 406 can precede the transfer function 404. In another example, the inverse color conversion 526 can be performed after the inverse transfer function 5284. In other examples, additional processing can also occur. For example, spatial subsampling may be applied to color components.

The transfer function 404 can be applied to the data in an image to compact the dynamic range of the data. Compacting the dynamic range may enable video content to represent the data with a limited number of bits. The transfer function 404 can be a one-dimensional, non-linear function that can either reflect the inverse of the electro-optical transfer function (EOTF) of an end consumer display (e.g., as specified for SDR in BT.709), or can approximate the human visual system's perception of brightness changes (e.g., as a provided for HDR by the perceptual quantizer (PQ) transfer function specified in ST 2084 for HDR). An electro-optical transfer function (EOTF) describes how to turn digital values, referred to as code levels or code values, into visible light. For example, the EOTF can map the code levels back to luminance. The inverse process of the electro-optical transform is the optical-electro transform (OETF), which produce code levels from luminance.

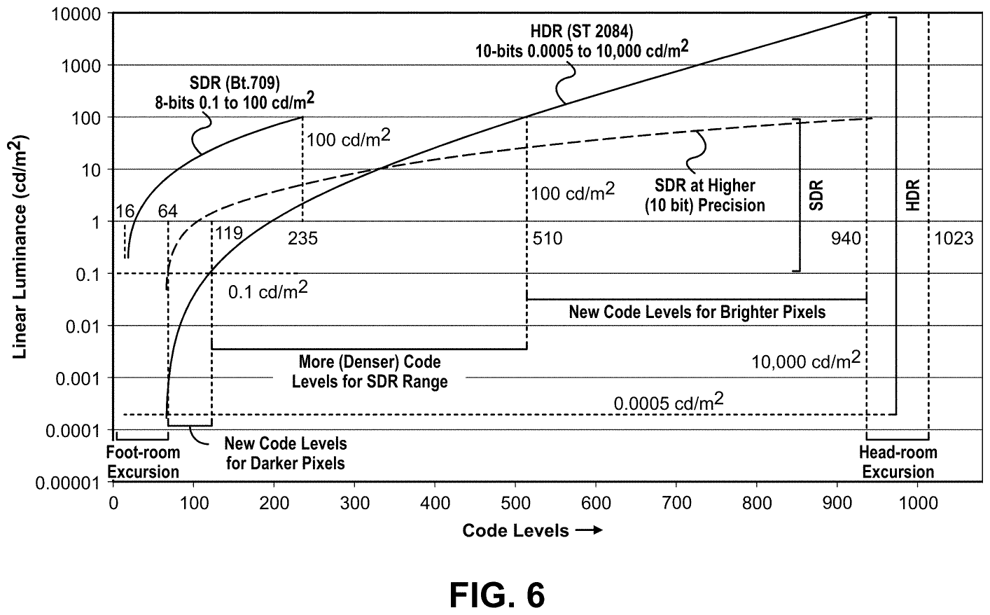

FIG. 6 illustrates examples of luminance curves produced by transfer functions defined by various standards. Each curve charts a luminance value at different code levels. FIG. 6 also illustrates dynamic range enabled by each transfer function. In other examples, curves can separately be drawn for red (R), green (G), and blue (B) color components.

The EOTF application as defined by the ST2084 specification will now be described, defined. The transfer function (TF) is applied to normalized linear R, G, B values, which results in a nonlinear representation of R′G′B′. ST2084 defines normalization by NORM=10000, which is associated with a peak brightness of 10000 nits (cd/m2).

$$\begin{matrix}{R}^{′} = PQ\_TF ( max ( 0 , min ( R / NORM , 1 ) ) ) & Equation ( 1 ) \\ {G}^{′} = PQ\_TF ( max ( 0 , min ( G / NORM , 1 ) ) ) & \\ {B}^{′} = PQ\_TF ( max ( 0 , min ( B / NORM , 1 ) ) ) . & \\ with {PQ}_{TF ( L )} = {( \frac{{c}_{1} + {c}_{2} {L}^{{m}_{1}}}{1 + {c}_{3} {L}^{{m}_{1}}} )}^{{m}_{2}} & \\ {m}_{1} = \frac{2610}{4096} \times \frac{1}{4} = 0.1593017578125 & \\ {m}_{2} = \frac{2523}{4096} \times 128 = 78.84375 & \\ {c}_{1} = {c}_{3} - {c}_{2} + 1 = \frac{3424}{4096} = 0.8359375 & \\ {c}_{2} = \frac{2413}{4096} \times 32 = 18.815625 & \\ {c}_{3} = \frac{2392}{4096} \times 32 = 18.6875 & \end{matrix}$$

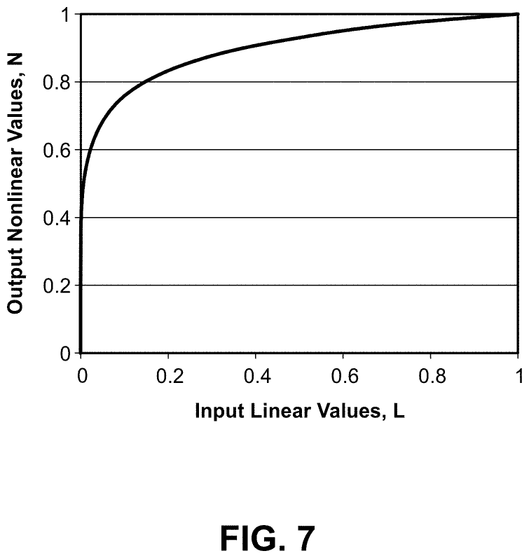

FIG. 7 is a graph illustrating a visualization of input values (linear color value) normalized to range 0 . . . 1 and normalized output values (nonlinear color value) of the PQ EOTF. As it is seen from the curve in FIG. 7, 1 percent (low illumination) of dynamical range of the input signal is converted to 50% of dynamical range of the output signal.

The EOTF can be defined as a function with a floating point accuracy, in which case no error is introduced to a signal with this non-linearity if the inverse TF (OETF) is applied. The inverse TF (OETF) specified in ST2084 is defined as an inversePQ function:

$$\begin{matrix}R = 10000 * inversePQ\_TF ( {R}^{′} ) & Equation ( 2 ) \\ G = 10000 * inversePQ\_TF ( {G}^{′} ) & \\ B = 10000 * inversePQ\_TF ( {B}^{′} ) & \\ with {inversePQ}_{TF ( N )} = {( \frac{max ⌊ ( {N}^{1 / {m}_{2 - {c}_{1}}} ) , 0 ⌋}{{c}_{2} - {{c}_{3}}^{1 / {m}_{2}}} )}^{1 / {m}_{1}} & \\ {m}_{1} = \frac{2610}{4096} \times \frac{1}{4} = 0.1593017578125 & \\ {m}_{2} = \frac{2523}{4096} \times 128 = 78.84375 & \\ {c}_{1} = {c}_{3} - {c}_{2} + 1 = \frac{3424}{4096} = 0.8359375 & \\ {c}_{2} = \frac{2413}{4096} \times 32 = 18.8515625 & \\ {c}_{3} = \frac{2392}{4096} \times 32 = 18.6875 & \end{matrix}$$

With floating point accuracy, the sequential application of EOTF and OETF provides a perfect reconstruction without errors. However, this representation may not be optimal for streaming or broadcasting services. More compact representation with fixed bits accuracy of nonlinear R′G′B′ data is described in following below. EOTF and OETF are only examples, and different transfer functions utilized in some HDR video coding systems may be different from those described in ST2084.

Color transform may be utilized to change color spaces. In many cases, RGB data is utilized as input, since it is produced by many image capturing sensors. However, the RGB color space has high redundancy among its components and is sometimes not optimal for compact representation. To achieve more compact and more robust representation, RGB components can be converted to a more uncorrelated color space that is more suitable for compression (e.g. luminance and chrominance, YCbCr). The YCbCr color space separates the brightness in the form of luminance and color information in different un-correlated components, including luma (Y), chroma-blue (Cb), and chroma-red (Cr).

Many modern video coding systems use the YCbCr color space, as specified in ITU-R BT.709 or ITU-R BT.709. For example, the YCbCr colour space in the BT.709 standard specifies the following conversion process from R′G′B′ to Y′CbCr (non-constant luminance representation):

$$\begin{matrix}{Y}^{′} = 0.2126 * {R}^{′} + 0.7152 * {G}^{′} + 0.0722 * {B}^{′} & Equation ( 3 ) \\ Cb = \frac{{B}^{′} - {Y}^{′}}{1.8556} & \\ Cr = \frac{{R}^{′} - {Y}^{′}}{1.5748} & \end{matrix}$$

The above can also be implemented using the following approximate conversion that avoids the division for the Cb and Cr components:

Y′=0.212600*R′+0.715200*G′+0.072200*B′

Cb=−0.114572*R′−0.385428*G′+0.500000*B′

Cr=0.500000*R′−0.454153*G′−0.045847*B′ Equation (4)

The ITU-R BT.2020 standard specifies the following conversion process from R′G′B′ to Y′CbCr (non-constant luminance representation):

$$\begin{matrix}{Y}^{′} = 0.2627 * {R}^{′} + 0.6780 * {G}^{′} + 0.0593 * {B}^{′} & Equation ( 5 ) \\ Cb = \frac{{B}^{′} - {Y}^{′}}{1.8814} & \\ Cr = \frac{{R}^{′} - {Y}^{′}}{1.4746} & \end{matrix}$$

The above can also be implemented using the following approximate conversion that avoids the division for the Cb and Cr components:

Y′=0.262700*R′+0.678000*G′+0.059300*B′

Cb=−0.139630*R′−0.360370*G′+0.500000*B′

Cr=0.500000*R′−0.459786*G′−0.040214*B′ Equation (6)

Both color spaces remain normalized, therefore, for the input values normalized in the range 0 . . . 1, the resulting values will be mapped to the range 0 . . . 1. Color transforms implemented with floating point accuracy can provide perfect reconstruction, in which case the process is lossless.

Quantization/fix point conversion can be performed, as described above. For example, the processing stages described above can be implemented in a floating point accuracy representation, thus they may be considered as lossless. However, this type of accuracy can be considered as redundant and expensive for many consumer electronics applications. In some cases, input data in a target color space can be converted to a target bit-depth fixed point accuracy. Certain studies show that 10-12 bits accuracy in combination with the PQ TF is sufficient to provide HDR data of 16 f-stops with distortion below the Just-Noticeable Difference. Data represented with 10 bits accuracy can be further coded with most of the state-of-the-art video coding solutions. The conversion process includes signal quantization and is an element of lossy coding, and is a source of inaccuracy introduced to converted data.

An example of such a quantization applied to code words in target color space is provided. In this example, the YCbCr is used, as shown below. Input YCbCr values represented in floating point accuracy are converted into a signal of fixed bit-depth BitDepthY for the Y value and BitDepthC for the chroma values (Cb, Cr):

D_{Y′}=Clip1_{Y}(Round((1<<(BitDepth_{Y}−8))*(219*Y′+16)))

D_{Cb}=Clip1_{C}(Round(1<<(BitDepth_{C}−8))(224*Cb+128)))

D_{Cr}=Clip1_{G}(Round((1<<(BitDepth_{G}−8))*(224*Cr+128))) Eq. (7)

### With

Round(x)=Sign(x)*Floor(Abs(x)+0.5)
Sign (x)=−1 if x<0, 0 if x=0, 1 if x>0
Floor(x) the largest integer less than or equal to x
Abs(x)=x if x>=0, −x if x<0
Clip1_{Y}(x)=Clip3(0, (1<<BitDepth_{Y})−1, x)
Clip1_{C}(x)=Clip3(0, (1<<BitDepth_{C})−1, x)
Clip3(x,y,z)=x if z<x, y if z>y, z otherwise

As described in more detail below, video coding methods according to standards such as MPEG and JVET can include dynamic range adjustment (DRA) applied to an output sample of a video coding scheme. The DRA can use parameters, such as scale and offset values, which are a function of the sample. By implementing the DRA, perceived distortion (e.g., in terms of signal to noise ratio) of encoded signals can be linearized within a dynamical range. In some examples, one video sample can be used to implement DRA over another video sample. For example, decoded luma components can be used to implement DRA over chroma components. In some implementations, the DRA can be implemented as a 1 tap filter. The 1 tap filter can be a function which includes scale and offset parameters which depend on the value of an input sample. In some implementations, other filters with multiple taps can be used.

In some implementations, the DRA can lead to redistribution of code words in video data (e.g., chroma or luma samples). For example, the DRA can result in redistribution of code words in video data included in a ST 2084/BT.2020 container, where the DRA can be applied prior to or in conjunction with applying a hybrid, transform-based video coding scheme (e.g., H.265/HEVC). In some examples, applying the DRA can include a forward mapping. The DRA or forward mapping which results in a corresponding redistribution of code words is also referred to as a reshaper or applying a reshaper function.

To compensate for this redistribution and to convert data to the original ST 2084/BT.2020 representation, an inverse DRA function can be applied. For example, the DRA and the inverse DRA can both be implemented at the encoding device 104 or the decoding device 112 in some implementations. For example, the DRA (or forward mapping) and the inverse DRA (or inverse mapping) can be applied as a two-step mechanism in the encoding device 104 or the decoding device 112 when an inter-prediction mode is utilized for predicting video samples. In some examples, if the DRA is applied at an encoder side on un-encoded video data (e.g., in the encoding device 104), the inverse DRA can be applied at a decoder side on encoded video data (e.g., at the decoding device 112) after the encoded video data has been decoded. As noted above, the DRA can also be referred to as a reshaper, and the inverse DRA can also be referred to as an inverse reshaper.

It is possible to implement the inverse DRA as a separate or standalone function. As will be explained in greater detail below, some implementations of the inverse DRA can involve applying one or more scaling and offset parameters, while in some implementations, the inverse DRA can be applied using a look-up table (LUT). In either of these implementations, applying the inverse DRA can involve respective processing resources. In some examples where the DRA function may be implemented only in HDR coding but not SDR coding, the processing resources for the inverse DRA may also be correspondingly utilized for HDR coding but not for SDR coding. Thus, there are advantages to minimizing the processing resources associated with the inverse DRA function.

According to example aspects discussed below, processing resources such as power consumption, implementation costs, and processing delays associated with applying the inverse DRA function can be reduced using techniques described herein. In some examples, reducing the processing resources associated with the inverse DRA function can include combining the inverse DRA function with one or more coding loop filters (also referred to as in-loop filters), such as deblocking filters, bilateral filters, sample adaptive offset (SAO) filters, interpolation filters, adaptive loop filters (ALFs), any combination thereof, and/or other coding loop filters. In some examples, combining the inverse DRA function with a coding loop filter can involve a combined (or integrated) inverse DRA and coding loop function. In some examples, the combined inverse DRA and coding loop function can be implemented using combined (or integrated) parameters for the inverse DRA and the coding loop function. In the following sections, examples of the parameters for the inverse DRA and coding loop functions will be described, followed by example techniques for implementing the combined inverse DRA and coding loop functions.

In some implementations of the DRA (or forward mapping or reshaper), a piece-wise linear function f(S) can be used for the redistribution of code words. In some examples, the piece-wise linear function f(S) can be defined for a group of non-overlapping dynamic range partitions (ranges) {Ri} of input value S, where S may be a sample or code words, and i may be an index of the range, with a range of 0 to N−1, inclusive, and where N is the total number of ranges {Ri} utilized for defining the DRA.

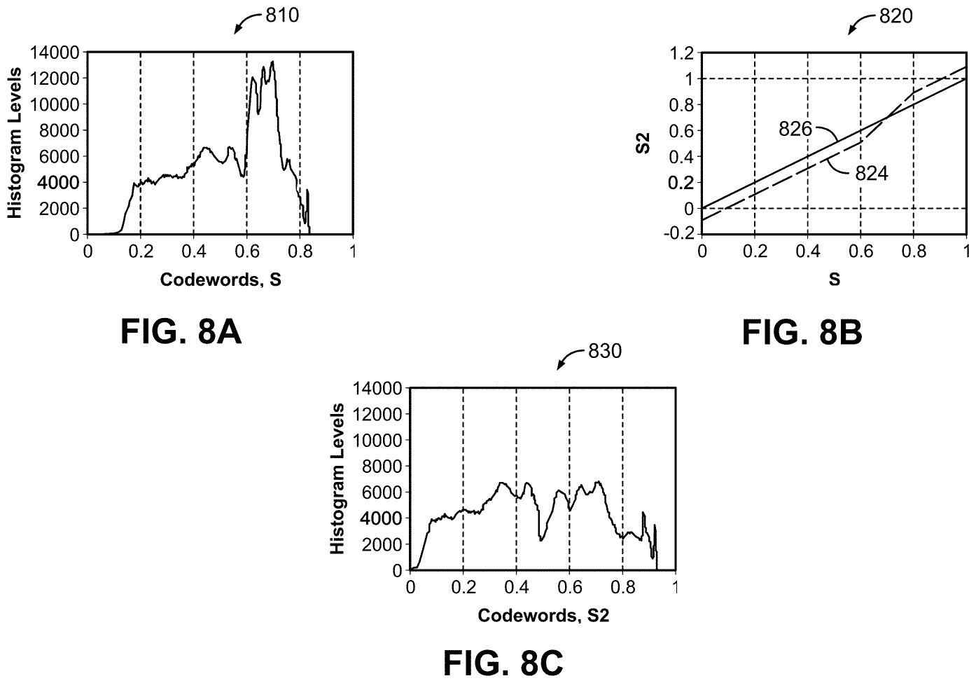

FIG. 8A-FIG. 8C are graphs which illustrate the use of a piece-wise linear transfer function for implementing the DRA. FIG. 8A illustrates a histogram 810 of code words for an input signal S, generated using a perceptual quantizer transfer function (PQTF) described with reference to FIG. 7 above. FIG. 8B illustrates transfer functions 820 which can be applied to the histogram 810 of FIG. 8A. The transfer functions 820 can include a linear transfer function 824 and a piece-wise linear transfer function 826. FIG. 8C illustrates a histogram 830 of code words produced by applying the piece-wise linear transfer function 826 to the histogram 810.

Referring to FIG. 8A in greater detail, the histogram 810 is shown to be broken up into segments corresponding to ranges {Ri} of code words on a normalized scale from 0 to 1. The code words in FIG. 8A are referred to as being in an original or un-reshaped domain, in which case a DRA function has not been applied. In FIG. 8A, for a value of i equal to 5, there are five segments identified and demarcated with vertical lines. The five segments may be referred to as {first, second, third, fourth, fifth} segments respectively, corresponding to the normalized code ranges {0-0.2, 0.2-0.4, 0.4-0.6, 0.6-0.8, 0.8-1} shown in FIG. 8A. As can be seen from the histogram 810, less than all available code words across all five segments are utilized (e.g., about 80% of available code words are utilized), while some code words (e.g., 20%) do not contribute to the histogram 810. Further, the histogram 810 also shows that a significant number of the higher histogram levels correspond to code words located in the fourth segment identified in the 0.6-0.8 range. By utilizing more of the available code words, quantization error can be improved, e.g., for this fourth segment, without impacting the accuracy of representation of the remaining segments.

In FIG. 8B, transfer functions 820 are shown. Specifically, the linear transfer function 824 is illustrated to provide a baseline. The piece-wise linear transfer function 826 can include both scale parameters and offset parameters relative to the linear transfer function 824. The scale and offset parameters may be applied to one or more segments of the histogram 810 to achieve a redistribution of the code words.

In the illustrated example, the scale and offset parameters for the i segments (where i=5, corresponding to the five segments shown in FIG. 8A) are illustrated as follows (illustrated as {segment 1, segment 2, segment 3, segment 4, segment 5}) in the piece-wise linear transfer function 826: scales={1,1,1,2,1}; offsets={−0.1,−0.1,−0.1,−0.1,0.1}. In more detail, the first, second, and third segments are scaled by a factor of 1 and offset by −0.1, the fourth segment is scaled by a factor of 2 and offset by −0.1, and the fifth segment is scaled by a factor of 1 and offset by 0.1. By applying the scales and offsets to the five segments, as above, the peaks in the fourth segment of the histogram 810 can be suppressed. Further, by applying the scales and offsets, the code words in the fourth segment (in the range 0.6-0.8 in FIG. 8A) are redistributed to the remaining segments, to utilize more of the available code words in the first and fifth segments. The code words in FIG. 8C, as a result of applying the piece-wise linear transfer function 826, are redistributed or reshaped. For example, as seen from the resulting histogram 830 (after applying the scales and offsets of the linear transfer function 826), more code words are occupied as a result of applying the piece-wise linear transfer function 826, as compared to the original distribution shown in FIG. 8A. Moreover, the peaks which were located in the fourth segment of the histogram 810 are reduced and code words thereof are redistributed across a larger dynamical range. The code words in FIG. 8C are referred to as being in a reshaped domain, where the reshaped domain is obtained by implementing reshaping or redistribution to the code words in the original domain in FIG. 8A.

In some examples, the piece-wise linear transfer function 826 corresponds to a DRA function, which transforms (or redistributes) the code words or video data samples in the original domain to the reshaped domain. In some examples, applying the DRA function on samples which include coded video data can provide higher accuracy of the representation of the video data and reduce quantization errors. In the examples illustrated in FIG. 8A-FIG. 8C, the parameters of the DRA function can include the number of partitions or segments in the dynamic range, the ranges of each of segment, and the scale and offset parameters for each segment, among other possible parameters. For example, the dynamic range for the DRA can be defined using a minimum and a maximum value “x” that belongs to the range Ri, e.g., [xᵢ, xᵢ₊₁−1], where xᵢ and xᵢ₊₁ denote minimum values of the ranges Rᵢ and Rᵢ₊₁ respectively.

In an example of the DRA (or forward mapping or reshaper function) applied to the Y color component of a video sample (i.e., a luma sample), a DRA function Sy can be defined using parameters including a scale S_{y,i} and offset O_{y,i}, which are applied to every x∈[xᵢ, xᵢ₊₁−1], thus S_{y}={S_{y,i}, O_{y,i}}.

With this representation, for any Ri, and each x∈[xᵢ, xᵢ₊₁−1], the output value X can be generated by applying the DRA using the following equation:

X=S_{y,i}*(x−O_{y,i}) Equation (8)

As previously mentioned, a corresponding inverse DRA (or inverse mapping or inverse reshaper function) can be used to perform a mapping of the redistributed code words in the reshaped domain to the code words or video samples in the original or domain (e.g., the luma sample). In examples which will be discussed in greater detail below, the inverse DRA function can be implemented using a combined inverse DRA and loop filter unit in a decoder such as the decoding device 112. In some examples, an inverse DRA function can be implemented on predicted video samples which are predicted according to a prediction mode (e.g., inter prediction or intra-prediction) to generate reconstructed samples.

In some examples, the inverse DRA function performed on the predicted luma components Y can be represented as Sy, where Sy is defined by the inverse of scale S_{y,i} and offset O_{y,i} values which are applied to every X∈[Xᵢ, Xᵢ₊₁−1]. Correspondingly, for any Ri, and each X∈[Xᵢ, X₊₁−1], a reconstructed value x can be calculated as follows:

x=X/S_{y,i}+O_{y,i} Equation (9)

In another example, the DRA (or forward mapping or reshaper function) applied to chroma components Cb and Cr can be defined as follows. In an example where the term “u” denotes a sample of the Cb color component that belongs to range Ri, u∈[uᵢ, uᵢ₊₁−1], the DRA can be defined as Sᵤ=(S_{u,i}, O_{u,i}):

U=S_{u,i}*(u−O_{y,i})+Offset Equation (10)

where Offset is equal to 2^{(bitdepth-1)} and denotes a bi-polar Cb, Cr signal offset.

The corresponding inverse DRA function (or inverse mapping or inverse reshaper function) for the chroma components Cb and Cr can be defined as follows. In examples which will be discussed in greater detail below, the inverse DRA function can be implemented using a combined inverse DRA and loop filter unit in a decoder such as the decoding device 112. In an example where the term “U” denotes a sample of a remapped Cb color component which belongs to the range Ri, U∈[Uᵢ, U₁₊₁−1] the inverse DRA function can be defined as

u=(U−Offset)/S_{u,i}+O_{y,i} Equation (11)

where Offset is equal to 2^{(bitdepth-1)} and denotes a bi-polar Cb, Cr signal offset.

Accordingly, the above examples illustrate the implementation of the inverse DRA function using equations such as the Equations 9 and 11. In these implementations, the scale and offset parameters can be used to generate the reconstructed values from predicted samples. In some implementations, logic or processing elements such as a multiplier can be used to implement scaling functions using the scaling parameters. Similarly, logic or processing elements such as an adder can be used to implement the offset functions using the offset parameters.

In alternative implementations, the inverse DRA function can be implemented using a look up table (LUT). For example, an inverse LUT (or “invLUT”) can be configured or programmed with reconstructed values which can be indexed using the predicted samples. Accordingly, the invLUT can be consulted using the predicted samples to generate corresponding reconstructed values. For example, given a value of one or more samples, an entry in the invLUT can be identified, and the reconstructed values (resulting from application of an inverse DRA function) can be obtained. The invLUT can be implemented using suitable logic or processing elements.

In some examples, the invLUT for the inverse DRA function can be implemented in a LUT, which can provide a mapping from an input pixel value “x” to an output pixel value “y”. An example mapping function which can be implemented using the invLUT can be of the format, y=x*scale(x)+offset(x), where the value of y can be obtained as an output of the invLUT by indexing the invLUT using the value of x. The scale and offset values can be parameters of the inverse DRA. The invLUT can be of any suitable size, e.g., 1024 entries storing values of y, which can be indexed using values of x, which can be input data samples. Since the invLUT lookup can implement the mapping function directly by looking up the value of y for each value of x, without calculating the value of y using the mapping function with scale and offset values, the invLUT can provide efficiencies. In some cases, with a large number of entries, the memory consumption for implementing the invLUT can increase.

In some implementations, the memory consumption can be reduced by implementing a reduced size invLUT that includes entries for ranges of index values. For example, values for scale(x) and offset(x) for a range of values of x can be stored in the reduced invLUT. The range of values of x can correspond to a number of entries, such as 16 entries or other number of entries. In such implementations, the output y can be obtained by performing additional computations on values obtained from looking up values in the reduced invLUT. For example, the value of y for a particular x can be obtained by performing a computation such as y=x*scale (index(x))+offset (index(x)), where index(x) can correspond to a reduced representation of a full dynamic range of values of x. In one illustrative example, the reduced representation of a full dynamic range can include index(x)=x>>6, which results in index values ranging from 0-15, for the range of x values from 0-1023. Such implementations using a reduced invLUT reduces memory consumption, since the reduced invLUT can include less than the 1024 entries in the above example. In some cases, there may be additional computations for performing the multiplication and addition using the scale and offset values obtained from the lookup of the invLUT.

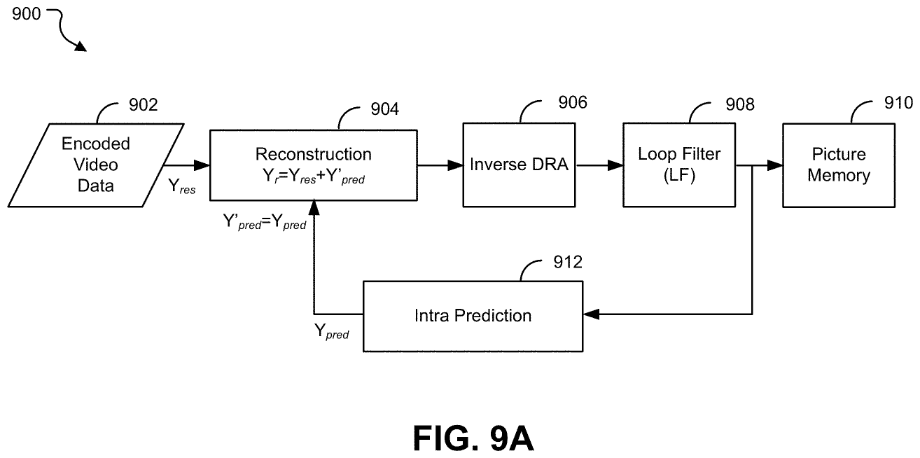

FIG. 9A and FIG. 9B are block diagrams illustrating decoding devices 900 and 950 in which the inverse DRA function can be implemented using LUTs. In some examples, a forward LUT (FwdLUT) can also be included, which may be an approximate inverse of the InvLUT for the inverse DRA function. For example, the decoding device 950 from FIG. 9B illustrates a FwdLUT (shown as forward DRA 954) and an InvLUT (shown as inverse DRA 906), where the FwdLUT and the InvLUT can be implemented as an approximately invertible pair of LUTs. The LUT-based implementation of the DRA and inverse DRA will be discussed in more detail below. In some examples, the decoding devices 900 and 950 can include alternative implementations of the decoding device 112. In some examples, which will be discussed in greater detail below, LUT-based implementations of the inverse DRA in the decoding devices 900 and 950 can be implemented in a combined inverse DRA and filter unit of the decoding device 112. While relevant aspects pertaining to the DRA implementation in the decoding devices 900 and 950 are depicted in FIG. 9A and FIG. 9B, specific additional details of the decoding devices 900 and 950 can be similar to those shown in the decoding device 112 shown and described with reference to FIG. 16.

In FIG. 9A, the decoding device 900 shows aspects of implementing intra prediction. In the example shown, encoded video data 902 may be received as an input. The encoded video data 902 can be received from an encoder such as the encoding device 104 shown and described with reference to FIG. 1 and FIG. 15. For example, the encoded video data 902 may be encoded based on context adaptive variable length coding (CAVLC), context adaptive binary arithmetic coding (CABAC), syntax-based context-adaptive binary arithmetic coding (SBAC), probability interval partitioning entropy (PIPE) coding, or another entropy encoding technique. In some examples, the encoded video data 902 may include reshaped encoded video data based on a DRA applied in the encoder. Thus, the encoded video data 902 can include signals in the reshaped domain.

The encoded video data 902 is processed in a loop which includes the intra prediction block 912 and the reconstruction block 904. The intra prediction block 912 can apply a prediction mode, which can include intra prediction as described above, on the encoded video data 902 to generate predicted video samples. The reconstruction block 904 can generate reconstructed video samples (denoted as Yᵣ) from the predicted video samples by combining the predicted samples (from the intra prediction block 912, denoted as Y′_{pred}) for a block or picture to residual samples (denoted as Yᵣₑₛ) for a block or picture. In this example, the inverse DRA block 906 can perform an InvLUT function, which generates reconstruction values from the signals received from the reconstruction block 904. The InvLUT function can map intra reconstructed values in the reshaped domain to intra reconstructed values in the original domain (before reshaping or DRA was applied). In an example, the InvLUT can be implemented as a one-dimensional, 10-bit, 1024-entry mapping table (1D-LUT). In an example, the InvLUT, can map the reshaped code values represented as Yᵣ to Ŷᵢ, where Ŷᵢ represents the reconstruction values of Yᵢ, as depicted by the notation: Ŷᵢ=InvLUT[Yᵣ]. In some examples, one or more in-loop filters can be applied on the output of the inverse DRA block 906 in the loop filter (LF) block 908 to generate a filtered output. The filtered output can be placed in the picture memory 910. In some examples, the picture memory 910 can include a decoded picture buffer, which can store reference pictures that can be used for inter prediction.

In FIG. 9B, the decoding device 950 shows aspects of implementing inter prediction. In the example shown, the encoded video data 902 can be received as an input, similar to the decoding device 900. In the decoding device 950, a motion compensation block block 952 and a forward DRA block 954 are shown in addition to the blocks shown and described with reference to the decoding device 900 of FIG. 9A. Accordingly, in the decoding device 950, both the DRA and the inverse DRA can be implemented for an inter-prediction mode used for predicting the video samples. For example, in the decoding device 950, a FwdLUT and an InvLUT may be applied respectively in the forward DRA block 954 and the inverse DRA block 906 for inter slices.

Accordingly in some examples, the decoding device 950 may be configured to process decoding operations for inter slices. The FwdLUT function implemented in the forward DRA block 954 can be used to map motion-compensation values received from the motion compensation block 952. The motion compensation block 952 can receive reconstructed samples from the picture memory 910 in the original domain and can perform motion compensation. Thus, the forward DRA block 954 can map the motion compensated samples from the motion compensation block 952 in the original domain to the reshaped domain. In the example shown, the forward DRA block 954 can implement the FwdLUT[Y_{pred}] function, where a one-dimensional, 10-bit, 1024-entry mapping table (1D-LUT) can be used to map input luma code values Yᵢ in the original domain to reshaped or altered values Yᵣ by using the LUT function. Yᵣ=FwdLUT[Yᵢ]. The InvLUT implemented by the inverse DRA block 906 can then map inter reconstructed values in the reshaped domain to inter reconstructed values in the original domain, as shown by the notation Ŷᵢ=InvLUT[Yᵣₑₛ+FwdLUT[Y_{pred}]]. In some examples, one or more in-loop filters can be applied on the output of the inverse DRA block 906 in the loop filter (LF) block 908 to generate a filtered output which may be placed in a decoded picture buffer or the picture memory 910.

As seen from FIG. 9A and FIG. 9B, the InvLUT is applied by the inverse DRA block 906 before loop filtering is applied for processing both intra and inter slices in the decoding devices 900 and 950. Accordingly in some examples, the LUTs can be pre-computed for applying the inverse DRA function. The InvLUT implementation can be used as an alternative to performing the scaling and offset functions on the fly (as samples are received), as previously described with reference to the piece-wise linear function implemented by the inverse DRA in some examples.

FIG. 10 is a block diagram illustrating another decoding device 1000. In some examples, the decoding device 1000 can include alternative implementations of the decoding device 112. In some examples which will be discussed in greater detail below, the LUT-based implementation of the inverse DRA in the decoding device 1000 can be implemented in a combined inverse DRA and filter unit of the decoding device 112.

As shown, the decoding device 1000 can implement the inverse DRA function after loop filtering is applied (by the loop filter (LF) block 1008) on the predicted samples. While the example shown in FIG. 10 is for intra prediction, a similar implementation as described in FIG. 9B can be used for inter prediction, with the inverse DRA function implemented after loop filtering. Thus, although the prediction blocks for inter prediction are not explicitly illustrated in FIG. 10, the decoding device 1000 can implement similar functionality as described with reference to FIG. 9B for inter prediction based on a prediction mode to generate the predicted samples. For example, the decoding device 1000 can also include a forward DRA block for implementing the DRA function for inter prediction.

As shown in FIG. 10, encoded video data 1002 can be an input to the decoding device 1000. For example, the encoded video data 1002 can be received from an encoding device such as the encoding device 104 shown and described with reference to FIG. 1 and FIG. 15. In some examples, the encoded video data 1002 may include reshaped encoded video data based on a DRA applied in the encoder. Thus, the encoded video data 1002 can include signals in the reshaped domain. In some examples, parameters for the DRA applied in the encoder can be received by the decoding device 1000 to enable the decoding device 1000 to implement corresponding inverse DRA functions.

According to an example, the encoded video data 1002 can be processed in a loop which includes an intra prediction block 1012 and the reconstruction block 1004. The intra prediction block 1012 can apply a prediction mode which includes intra prediction on the encoded video data 1002, to generate predicted video samples. The reconstruction block 1004 can generate reconstructed video samples (denoted as Yᵣ) from the predicted video samples by combining the predicted samples (from the intra prediction block 1012, denoted as Y_{pred}) for a block or picture to residual samples (denoted as Yᵣₑₛ) for a block or picture. In this example, one or more loop filters may be applied on the reconstructed video samples in the LF block 1008. The inverse DRA block 1006 can perform an InvLUT function (or can apply DRA based scale and offset parameters, as described above), which generates reconstruction values from the signals received from the LF block 1008. The InvLUT function can map intra reconstructed values in the reshaped domain to intra reconstructed values in the original domain before reshaping or DRA was applied. In an example, the InvLUT can be implemented as a one-dimensional, 10-bit, 1024-entry mapping table (1D-LUT). In an example, the InvLUT, can map the reshaped code values represented as Yᵣ to Ŷᵢ, where Ŷᵢ represents the reconstruction values of Yᵢ, as depicted by the notation: Ŷᵢ=InvLUT[Yᵣ]. In some examples, the output of the inverse DRA block 1006 may be placed in the picture memory 1010 (e.g., a decoded picture buffer).

In the field of video coding, it is common to apply filtering on reconstructed samples in order to enhance the quality of a decoded video signal. The filter can be applied as a post-filter, where a filtered picture is not used for prediction of future pictures, or can be applied as an in-loop filter, where a filtered picture is used to predict future pictures (by being stored in the picture memory 1010). A filter can be designed, for example, by minimizing the error between the original signal and the decoded filtered signal. For example, the one or more loop filters in the LF blocks 908 (from FIG. 9A and FIG. 9B) and 1008 (from FIG. 10) can include one or more filters such as SAO filter, ALF, bilateral filter, deblocking filter, any combination thereof, and/or other filter, which can be applied to enhance the quality of the decoded video signals processed by the decoding devices 900, 950, and 1000 shown in FIG. 9A, FIG. 9B, and FIG. 10, respectively.

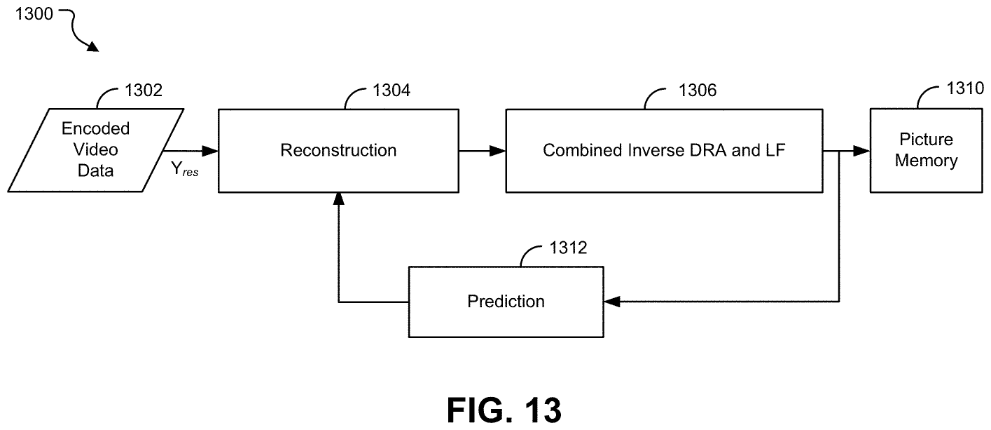

Some filters in the LF blocks 908, 1008 can involve convolution operations, which can be implemented using multiplication and addition operations or using look-up tables (LUTs). In the example implementations of the decoding devices 900, 950 described above, the LF block 908 appears after the inverse DRA block 906, while in the example implementation of the decoding device 1000, the LF block 1008 appears before the inverse DRA block 1006. In either type of implementation, the inverse DRA block and the LF block are implemented in sequence, in either a forward order (e.g., in the decoding devices 900, 950) or a reverse order (e.g., in the decoding device 1000). As can be appreciated from the above discussion, the inverse DRA block and the LF block can both involve functions performed on predicted video samples to generate reconstructed video samples, where the functions can be implemented using multiplication and addition operations or using LUTs. Since either implementation of the functions involves processing resources, these functions can be combined to realize efficiencies in aspects of this disclosure. For example, a combined (or integrated) inverse DRA and LF function can be implemented, where the common operations are performed on integrated or combined parameters of both the inverse DRA and the LF function to avoid additional processing resources that may be incurred when the DRA and LF functions are performed separately in a serial manner as described above. As will be discussed with reference to FIG. 13 below, the decoding device 112 can include a combined inverse DRA and filter unit 1306 to implement a combined inverse DRA and LF function. Examples of such combined inverse DRA and LF functions will now be discussed.

FIG. 11 is a block diagram which illustrates an example implementation of a bilateral filter. The bilateral filter can be one of the filters which can be implemented in a loop filter block such as LF block 908 or 1008. The bilateral filter modifies a current sample based on a weighted average of the samples in its neighborhood. The weights used in the weighted average are derived based on the distance of the neighboring samples from the current sample and the difference in the sample values of the current sample and the neighboring samples. In some examples, the samples which are modified by the bilateral filter can include predicted samples. The weights applied in the weighted average can be provided as parameters for the bilateral filter, where the weights can be obtained from the encoded video signals.

In FIG. 11. P_{0,0} is the intensity of the current sample and P_{0,0}′ is the modified intensity of the current sample which results from applying the bilateral filtering process. P_{k,0} and Wₖ are the intensity and weighting parameter for the k-th neighboring sample, respectively. Four neighboring samples are illustrated in FIG. 11, where k=4, and the neighboring sample intensities are shown as P_{1,0}P_{2,0}P_{3,0} and P_{4,0}. The bilateral filter can then be defined using the following equation:

P_{o,o}′=P_{0,0}+Σₖ₌₁^{K}Wₖ(abs(P_{k,0}−P_{0,0}))×(P_{k,0}−P_{0,0}) Equation (12)

More specifically, the weight Wₖ(x) associated with the k-th neighboring sample is defined as follows:

$$\begin{matrix}{W}_{k} ( x ) = {Distance}_{k} \times {Range}_{k} ( x ) & Equation ( 13 ) \\ where , & \\ {Distance}_{k} = {e}^{( - \frac{10000}{2 {σ}_{d}^{2}} )} / 1 + 4 * {e}^{( - \frac{10000}{2 {σ}_{d}^{2}} )} & Equation ( 14 ) \\ {Range}_{k} ( x ) = {e}^{( - \frac{{x}^{2}}{a \cdot ( QP - 17 ) \cdot ( QP - 17 )} )} & Equation ( 15 )\end{matrix}$$

and σ_{d} is dependent on the coded mode and coding block sizes. The above-described bilateral filtering can be applied to intra-coded blocks and/or inter-coded blocks.

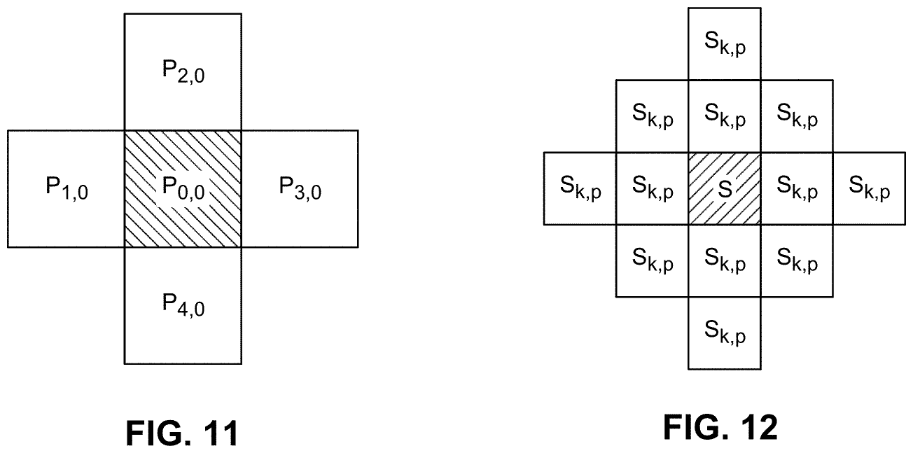

FIG. 12 is a block diagram which illustrates an example implementation of an adaptive loop filter (ALF). The ALF can also be one of the filters which can be implemented in a loop filter block such as LF block 908 or 1008 (in addition to or as an alternative to the bilateral filter of FIG. 11). The ALF implements a convolution of neighboring samples with certain filter coefficients to produce an output sample. For example, in FIG. 12, the filter sample identified as S is generated based on a convolution of neighboring samples generally identified as S_{k,p} for values of k and p which cover a diamond shape around the sample S. Each of these samples S_{k,p} are scaled or multiplied by respective filter coefficients scaleALF_{k,p} and the scaled value is added to a respective offset, offsetALFA_{k,p} and normalized (Norm) across all samples in the neighborhood. The ALF output for the sample S is then generated by the following equation:

S=sum(S_{k,p}*scaleALF_{k,p}+offsetALF_{k,p})/Norm Equation (16)

Referring to Equations 12 and 16 above, both the bilateral filter of FIG. 11 and the ALF of FIG. 12 are seen to include multiplication and addition operations using corresponding parameters. In more detail, the bilateral filtering function of Equation 12 can be implemented using an offset parameter P_{0,0} and a scaling parameter (P_{k,0}−P_{0,0}) for each sample. Similarly, the ALF of Equation 16 can be implemented using an offset parameter offsetALF_{k,p} and a scaling parameter scaleALFₖ, for each sample. As previously discussed with reference to Equations 9 and 11, the inverse DRA function can be implemented with one or more offset parameters and one or more scaling parameters. In some implementations, e.g., as discussed with reference to FIG. 9A-FIG. 9B and FIG. 10, the inverse DRA function can also be implemented with an LUT such as the InvLUT. Accordingly, one or more parameters of the inverse DRA function can be combined with respective one or more parameters of one of the filters discussed above.

FIG. 13 is a block diagram illustrating another example of a decoding device 1300. The decoding device 1300 can include an implementation of the decoding device 112 of FIG. 16. In some examples, the decoding device 1300 may implement a combined inverse DRA and loop filtering function on the predicted samples. As shown in FIG. 13, encoded video data 1002 can be an input to the decoding device 1300. For example, the encoded video data 1302 can be received from an encoding device such as the encoding device 104 shown and described with reference to FIG. 1 and FIG. 15. In some examples, the encoded video data 1302 may include reshaped encoded video data based on a DRA applied by the encoding device. Thus, the encoded video data 1302 can include signals in the reshaped domain. In some examples, parameters for the DRA applied by the encoding device can be received by the decoding device 1300 to enable the decoding device 1300 to implement corresponding inverse DRA functions.

According to an example, the encoded video data 1302 can be processed in a loop, which can include a prediction block 1312 and a reconstruction block 1304 (and any other components not shown in FIG. 13 that may be used between the prediction block 1312 and the reconstruction block 1304). The prediction block 1312 can include an intra prediction block to apply an intra-prediction mode and/or can include an inter prediction block to apply an inter-prediction mode. In some examples, one or more of intra prediction and inter prediction can be applied in the prediction block 1312. In some examples, a combined inverse DRA and LF function can be applied in the combined inverse DRA and LF block 1306 to predicted samples in a reshaped domain. In some examples, applying the combined inverse DRA and LF function in the combined inverse DRA and LF block 1306 to the predicted samples can generate reconstructed video samples. In some examples, the output of the combined inverse DRA and LF block 1306 (the reconstructed video samples) can be stored in the picture memory 1010 (e.g., a decoded picture buffer) as reconstructed (or decoded) pictures.

According to an example, the combined inverse DRA and LF block 1306 can implement an inverse DRA combined with a bilateral filter. For example, one or more parameters of the inverse DRA function can be combined (or integrated) with one or more parameters of the bilateral filter to apply a combined inverse DRA and bilateral filter on predicted samples. The following equation represents a combined inverse DRA and bilateral filter (where Wₖ(x) is a weight associated with the k-th neighboring sample as defined in Equation 13 above):

P_{0,0}′=(P_{0,0}−offsetDRA1+Σₖ₌₁^{K}Wₖ(P_{k,0}−P_{0,0})×(P_{k,0}−P_{0,p}))*scaleDRA+offsetDRA2, Equation (17)

In Equation 17, parameters of the inverse DRA include a scaling parameter scaleDRA and offset parameters offsetDRA1 and offsetDRA2; and parameters of the bilateral filter include a scaling parameter (P_{k,0}−P_{0,0}) and an offset parameter P_{0,0}.

In some examples, the combined inverse DRA and bilateral filter can be implemented by performing the functions shown in Equation 17 using the combined inverse DRA and bilateral filter parameters. In some examples, the combined inverse DRA and bilateral filter parameters can be stored in a look-up table (LUT) similar to the InvLUT shown in the inverse DRA blocks 906, 1006.

According to another example, the combined inverse DRA and LF block 1306 can implement an inverse DRA combined with an adaptive loop filter (ALF). For example, one or more parameters of the inverse DRA function can be combined with one or more parameters of the ALF to apply a combined inverse DRA and ALF on predicted samples. The following equation represents a combined inverse DRA and ALF:

S=sum((S_{k,p}−offsetDRA1_{k,p})*scaleALF_{k,p}*scaleDRA_{k,p}+offsetALF_{k,p}+offsetDRA2_{k,p})/Norm Equation (18)

In Equation 18, parameters of the inverse DRA include a sealing parameter scaleDRAₖₚ, and offset parameters offsetDRA1_{k,p} and offsetDRA2_{k,p}; parameters of the ALF include a scaling parameter scaleALF_{k,p} and an offset parameter offsetALFₖ. The sum calculated in Equation 18 can be referred to as a kernel, where “/Norm” indicates a normalization which can be performed on the sum. The normalization includes a division of each term (also referred to as a kernel element) by the sum of all kernel elements, such that the sum of elements of a normalized kernel is one. In some examples, the normalization in convolution filtering may be introduced to ensure that an average pixel value in a modified signal can remain in the same average brightness range as an input signal.

In some examples, the combined inverse DRA and ALF can be implemented by performing the functions shown in Equation 18 using the combined inverse DRA and ALF parameters. In some examples, the combined inverse DRA and ALF parameters can be stored in a look-up table (LUT) similar to the InvLUT shown in the inverse DRA blocks 906, 1006.

In some examples, when the DRA (or forward mapping or reshaping) is performed on the code words or video samples, the respective DRA parameters (e.g., one or more scaling parameters, one or more offset parameters, one or more ranges for segments, number of segments, etc., such as those noted above with respect to FIG. 8A) can be provided by signaling mechanisms. In some examples, an encoding device such as the encoding device 104 can perform the DRA and can include the DRA parameters in signaling data (e.g., in a parameter set, such as an Adaptation Parameters Set (APS), Picture Parameters Set (PPS), Sequence Parameters Set (SPS), and/or Video Parameters Set (VPS), in a slice header, in one or more SEI messages sent in or separately from the video bitstream, or in other signaling mechanisms) that is sent along with the encoded video data. In some examples, the DRA parameters can be signaled from a forward DRA block implemented within a decoding device such as the decoding device 950 for inter predicted samples.

In some examples, the aspects of combining the one or more inverse DRA parameters with the one or more loop filter parameters as discussed above, for implementing a combined inverse DRA and LF block 1306, can be enabled or disabled. In some examples, enabling the combining of the one or more inverse DRA parameters with the one or more loop filter parameters can include performing the combining of the one or more inverse DRA parameters with the one or more loop filter parameters as discussed with reference to the decoding device 1300. In some examples, disabling the combining of the one or more inverse DRA parameters with the one or more loop filter parameters can include not performing the combined inverse DRA and loop filter function, but implementing the inverse DRA and the loop filter functions separately in either order, e.g., as discussed with reference to the decoding devices 900, 950, and 1000. In some examples, enabling or disabling the combining of the one or more inverse DRA parameters with the one or more loop filter parameters can be implemented using signaling mechanisms which can be provided in conjunction with the one or more DRA parameters. In some examples, the signaling of the enabling or disabling DRA the combining of the one or more inverse DRA parameters with the one or more loop filter parameters can be included at any suitable level of signaling between devices (e.g., between the encoding device 104 and the decoding device 112) or within a device (such as the decoding device 112). The suitable levels can include a PPS, SPS, VPS, slice (e.g., in a slice header), CTU, CU, PU, and/or TU levels. The signaling can also include one or more SEI messages signaled in or separately from the video bitstream.

In addition to the bilateral filter and the ALF discussed above, the loop filters that can be combined with a DRA function, as described in this disclosure, can also include deblocking filters, sample adaptive offset (SAO) filters, or other type of coding loop filter. In some examples, the inverse DRA can be combined with any other loop filter other than the bilateral filter and the ALF. In some examples, the inverse DRA can be combined with only one of the loop filters. In some examples, the inverse DRA can be combined with more than one of the loop filters.

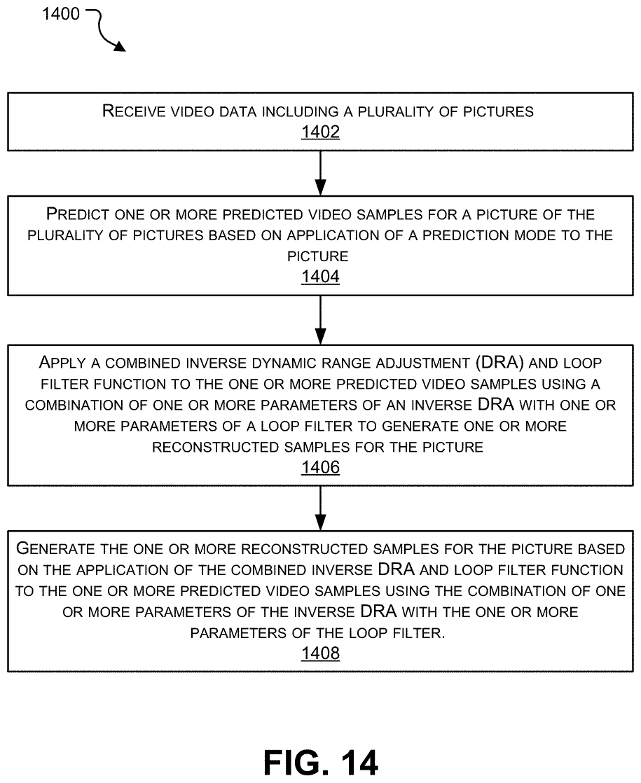

FIG. 14 is a flowchart illustrating an example of a process 1400 of processing video data using one or more of the combined inverse DRA and loop filter techniques described herein. At 1402, the process 1400 includes receiving video data including a plurality of pictures. In some examples, the video data can include encoded video data (e.g., an encoded video bitstream such as the encoded video data 1302), such as when the process 1400 is performed by a decoding device such as the decoding device 1300. In some examples, the video data can include un-encoded video data, such as when the process 1400 is performed by an encoding device such as the encoding device 104. The video data can include a plurality of pictures, and the pictures can be divided into a plurality of blocks, as previously described.

At 1404, the process 1400 includes predicting one or more predicted video samples for a picture of the plurality of pictures based on application of a prediction mode to the picture. For example, the prediction block 1312 can perform intra prediction and/or inter prediction on predicted video samples obtained at the decoding device 1300 based on the prediction mode.

At 1406, the process 1400 includes applying a combined inverse dynamic range adjustment (DRA) function and in-loop filter to the one or more predicted video samples using a combination of one or more parameters of an inverse DRA with one or more parameters of a loop filter to generate one or more reconstructed samples for the picture. For example, the combined inverse DRA and LF block 1306 can implement a combined inverse dynamic range adjustment (DRA) function and in-loop filter function, such as a combined inverse DRA and bilateral filter of Equation 17 using the combined inverse DRA and bilateral filter parameters (e.g., as combined in Equation 17). In another example, the combined inverse DRA and LF block 1306 can implement a combined inverse dynamic range adjustment (DRA) function and in-loop filter function such as the combined inverse DRA and ALF of Equation 18 using the combined inverse DRA and ALF parameters (e.g., as combined in Equation 18). One of ordinary skill will appreciate that the combination of the one or more parameters of the inverse DRA function with the one or more parameters of the in-loop filter can include one or more parameters of any type of in-loop filter (or post-loop filter in some cases). In some cases, the one or more parameters of the inverse DRA function can be combined with parameters of multiple in-loop filters.

In some examples, the one or more parameters of the inverse DRA include one or more inverse DRA scale values and one or more inverse DRA offset values. For example, referring to Equation 17 where the loop filter is a bilateral filter, the one or more parameters of the inverse DRA can include the scaleDRA, offsetDRA1, and offsetDRA2. In another example, referring to Equation 18 where the loop filter is a an ALF, the one or more parameters of the inverse DRA can include the scaleDRA_{k,p}, offsetDRA1_{k,p}, and offsetDRA2_{k,p}.

In some examples, the one or more parameters of the loop filter include one or more loop filter scale values and one or more loop filter offset values. For example, referring to Equation 17 where the loop filter is a bilateral filter, the one or more parameters of the bilateral filter include include an offset parameter P_{0,0} and a scaling parameter (P_{k,0}−P_{0,0}). In another example, referring to Equation 18 where the loop filter is an ALF, the one or more parameters of the ALF include scaleALF_{k,p} and offsetALF_{k,p}.

In some examples, the combination of the one or more parameters of the inverse DRA with the one or more parameters of the loop filter includes a combination of the one or more inverse DRA scale values with the one or more loop filter scale values, and a combination of the one or more inverse DRA offset values with the one or more loop filter offset values.

In some examples, a lookup table may be provided to store the combination of the one or more parameters of the inverse DRA with the one or more parameters of the loop filter. In some examples, the one or more parameters of the inverse DRA can be obtained from an inverse DRA lookup table (e.g., an InvLUT) using the one or more predicted video samples. In some examples, the one or more parameters of the loop filter can be obtained from a loop filter lookup table using the one or more predicted video samples.

At 1408, the process 1400 includes generating the one or more reconstructed samples for the picture based on the application of the combined inverse DRA and loop filter function to the one or more predicted video samples using the combination of one or more parameters of the inverse DRA with the one or more parameters of the loop filter. For example, the reconstruction block 1304 can generate the one or more reconstructed samples for the picture based on the application of the combined inverse DRA and loop filter function in the combined inverse DRA and LF block 1306 to the one or more predicted video samples using the combination of one or more parameters of the inverse DRA with the one or more parameters of the loop filter.

In some implementations, the processes (or methods) described herein can be performed by a computing device or an apparatus, such as the system 100 shown in FIG. 1. For example, the processes can be performed by the encoding device 104 shown in FIG. 1 and FIG. 15, by another video source-side device or video transmission device, by the decoding device 112 shown in FIG. 1 and FIG. 16, the decoding device 1300 shown in FIG. 13 and/or by another client-side device, such as a player device, a display, or any other client-side device. In some cases, the computing device or apparatus may include a processor, microprocessor, microcomputer, or other component of a device that is configured to carry out the steps of the processes described herein. The components of the computing device (e.g., the one or more processors, one or more microprocessors, one or more microcomputers, and/or other component) can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. In some examples, the computing device or apparatus may include a camera configured to capture video data (e.g., a video sequence) including video frames. In some examples, a camera or other capture device that captures the video data is separate from the computing device, in which case the computing device receives or obtains the captured video data. The computing device may further include a network interface configured to communicate the video data. The network interface may be configured to communicate Internet Protocol (IP) based data or other type of data. In some examples, the computing device or apparatus may include a display for displaying output video content, such as samples of pictures of a video bitstream.

The processes can be described with respect to logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The coding techniques discussed herein may be implemented in an example video encoding and decoding system (e.g., system 100). In some examples, a system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above is merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

The input interface of the destination device receives information from the computer-readable medium. The information of the computer-readable medium may include syntax information defined by the video encoder, which is also used by the video decoder, that includes syntax elements that describe characteristics and/or processing of blocks and other coded units, e.g., group of pictures (GOP). A display device displays the decoded video data to a user, and may comprise any of a variety of display devices such as a cathode ray tube (CRT), a liquid crystal display (LCD), a plasma display, an organic light emitting diode (OLED) display, or another type of display device. Various embodiments of the application have been described.

Specific details of the encoding device 104 and the decoding device 112 are shown in FIG. 15 and FIG. 16, respectively. FIG. 15 is a block diagram illustrating an example encoding device 104 that may implement one or more of the techniques described in this disclosure. Encoding device 104 may, for example, generate the syntax structures described herein (e.g., the syntax structures of a VPS, SPS, PPS, or other syntax elements). Encoding device 104 may perform intra-prediction and inter-prediction coding of video blocks within video slices. As previously described, intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode), may refer to any of several temporal-based compression modes.

The encoding device 104 includes a partitioning unit 35, prediction processing unit 41, combined inverse DRA and filter unit 63, picture memory 64, summer 50, transform processing unit 52, quantization unit 54, and entropy encoding unit 56. Prediction processing unit 41 includes motion estimation unit 42, motion compensation unit 44, and intra-prediction processing unit 46. For video block reconstruction, encoding device 104 also includes inverse quantization unit 58, inverse transform processing unit 60, and summer 62. Combined inverse DRA and filter unit 63 is intended to represent a block for applying an inverse DRA combined with one or more loop filters such as a deblocking filter, an adaptive loop filter (ALF), and a sample adaptive offset (SAO) filter, using the above-described techniques. For example, the Combined inverse DRA and filter unit 63 can apply a combined inverse dynamic range adjustment (DRA) and loop filter function to the one or more predicted video samples using a combination of one or more parameters of the inverse DRA function with one or more parameters of the in-loop filter to generate one or more reconstructed samples for the picture. Although the combined inverse DRA and filter unit 63 is shown in FIG. 15 as being an in-loop filter, in other configurations, a loop filter in the combined inverse DRA and filter unit 63 may be implemented as a post loop filter. A post processing device 57 may perform additional processing on encoded video data generated by the encoding device 104. The techniques of this disclosure may in some instances be implemented by the encoding device 104. In other instances, however, one or more of the techniques of this disclosure may be implemented by post processing device 57.

As shown in FIG. 15, the encoding device 104 receives video data, and partitioning unit 35 partitions the data into video blocks. The partitioning may also include partitioning into slices, slice segments, tiles, or other larger units, as wells as video block partitioning, e.g., according to a quadtree structure of LCUs and CUs. The ncoding device 104 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). Prediction processing unit 41 may provide the resulting intra- or inter-coded block to summer 50 to generate residual block data and to summer 62 to reconstruct the encoded block for use as a reference picture.

Intra-prediction processing unit 46 within prediction processing unit 41 may perform intra-prediction coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices, or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in picture memory 64. For example, the encoding device 104 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by the decoding device 112 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction unit processing 46 may select an appropriate intra-prediction mode to use from the tested modes. For example, intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by entropy encoding unit 56, the encoded bitstream may be transmitted to the decoding device 112, or archived for later transmission or retrieval by the decoding device 112. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in picture memory 64. The reference block may be used by motion estimation unit 42 and motion compensation unit 44 as a reference block to inter-predict a block in a subsequent video frame or picture.

In this manner, the encoding device 104 of FIG. 15 represents an example of a video encoder configured to derive LIC parameters, adaptively determine sizes of templates, and/or adaptively select weights. The encoding device 104 may, for example, derive LIC parameters, adaptively determine sizes of templates, and/or adaptively select weights sets as described above. For instance, the encoding device 104 may perform any of the techniques described herein, including the processes described above with respect to FIG. 14. In some cases, some of the techniques of this disclosure may also be implemented by post processing device 57.

FIG. 16 is a block diagram illustrating an example decoding device 112. The decoding device 112 includes an entropy decoding unit 80, prediction processing unit 81, inverse quantization unit 86, inverse transform processing unit 88, summer 90, combined inverse DRA and filter unit 91, and picture memory 92. Prediction processing unit 81 includes motion compensation unit 82 and intra prediction processing unit 84. The decoding device 112 may, in some examples, perform a decoding pass generally reciprocal to the encoding pass described with respect to the encoding device 104 from FIG. 15.

During the decoding process, the decoding device 112 receives an encoded video bitstream that represents video blocks of an encoded video slice and associated syntax elements sent by the encoding device 104. In some embodiments, the decoding device 112 may receive the encoded video bitstream from the encoding device 104. In some embodiments, the decoding device 112 may receive the encoded video bitstream from a network entity 79, such as a server, a media-aware network element (MANE), a video editor/splicer, or other such device configured to implement one or more of the techniques described above. Network entity 79 may or may not include the encoding device 104. Some of the techniques described in this disclosure may be implemented by network entity 79 prior to network entity 79 transmitting the encoded video bitstream to the decoding device 112. In some video decoding systems, network entity 79 and the decoding device 112 may be parts of separate devices, while in other instances, the functionality described with respect to network entity 79 may be performed by the same device that comprises the decoding device 112.

The entropy decoding unit 80 of the decoding device 112 entropy decodes the bitstream to generate quantized coefficients, motion vectors, and other syntax elements. Entropy decoding unit 80 forwards the motion vectors and other syntax elements to prediction processing unit 81. The decoding device 112 may receive the syntax elements at the video slice level and/or the video block level. Entropy decoding unit 80 may process and parse both fixed-length syntax elements and variable-length syntax elements in or more parameter sets, such as a VPS, SPS, and PPS.

When the video slice is coded as an intra-coded (I) slice, intra prediction processing unit 84 of prediction processing unit 81 may generate prediction data for a video block of the current video slice based on a signaled intra-prediction mode and data from previously decoded blocks of the current frame or picture. When the video frame is coded as an inter-coded (i.e., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within a reference picture list. The decoding device 112 may construct the reference frame lists, List 0 and List 1, using default construction techniques based on reference pictures stored in picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by the encoding device 104 during encoding of the video blocks to calculate interpolated values for sub-integer pixels of reference blocks. In this case, motion compensation unit 82 may determine the interpolation filters used by the encoding device 104 from the received syntax elements, and may use the interpolation filters to produce predictive blocks.

Inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. Inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, the decoding device 112 forms a decoded video block by summing the residual blocks from inverse transform processing unit 88 with the corresponding predictive blocks generated by motion compensation unit 82. Summer 90 represents the component or components that perform this summation operation. If desired, loop filters (either in the coding loop or after the coding loop) may also be used to smooth pixel transitions, or to otherwise improve the video quality. The combined inverse DRA and filter unit 91 is intended to represent a block for applying an inverse DRA function combined with one or more loop filters such as a deblocking filter, an adaptive loop filter (ALF), and a sample adaptive offset (SAO) filter. Although the loop filter in the combined inverse DRA and filter unit 91 shown in FIG. 16 can be an in-loop filter, in other configurations, the filter in the combined inverse DRA and filter unit 91 may be implemented as a post loop filter. The decoded video blocks in a given frame or picture are then stored in picture memory 92, which stores reference pictures used for subsequent motion compensation. Picture memory 92 also stores decoded video for later presentation on a display device, such as video destination device 122 shown in FIG. 1.

In this manner, the decoding device 112 of FIG. 16 represents an example of a video decoder configured to derive LIC parameters, adaptively determine sizes of templates, and/or adaptively select weights. The decoding device 112 may, for example, derive LIC parameters, adaptively determine sizes of templates, and/or adaptively select weights sets as described above. For instance, the decoding device 112 may perform any of the techniques described herein, including the processes described above with respect to FIG. 14.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set, “one or more of” a set” indicates that one member of the set or multiple members of the set satisfy the claim. For example, claim language reciting “at least one of A and B” means A, B, or A and B. In another example, claim language reciting “one or more of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method for processing video data, the method comprising:
receiving encoded video data including a plurality of pictures;
predicting one or more predicted video samples for a picture of the plurality of pictures based on application of a prediction mode to the picture;
applying a combined inverse dynamic range adjustment (DRA) and loop filter function to the one or more predicted video samples using a combination of one or more parameters of an inverse DRA with one or more parameters of a loop filter to generate one or more reconstructed samples for the picture; and
generating the one or more reconstructed samples for the picture based on the application of the combined inverse DRA and loop filter function to the one or more predicted video samples using the combination of one or more parameters of the inverse DRA with the one or more parameters of the loop filter.

2. The method of claim 1, wherein:
the one or more parameters of the inverse DRA comprise one or more inverse DRA scale values and one or more inverse DRA offset values;
the one or more parameters of the loop filter comprise one or more loop filter scale values and one or more loop filter offset values; and
the combination of the one or more parameters of the inverse DRA with the one or more parameters of the loop filter comprises a combination of the one or more inverse DRA scale values with the one or more loop filter scale values, and a combination of the one or more inverse DRA offset values with the one or more loop filter offset values.

3. The method of claim 2, further comprising a lookup table for storing the combination of the one or more parameters of the inverse DRA with the one or more parameters of the loop filter.

4. The method of claim 1, wherein the one or more parameters of the inverse DRA are obtained from an inverse DRA lookup table using the one or more predicted video samples.

5. The method of claim 1, wherein the one or more parameters of the loop filter are obtained from a loop filter lookup table using the one or more predicted video samples.

6. The method of claim 1, wherein the loop filter comprises a bilateral filter.

7. The method of claim 1, wherein the loop filter comprises an adaptive loop filter (ALF).

8. The method of claim 1, wherein the loop filter comprises a sample adaptive offset (SAO) filter.

9. The method of claim 1, wherein the loop filter comprises a deblocking filter.

10. The method of claim 1, wherein the loop filter comprises two or more of a bilateral filter, an adaptive loop filter (ALF), a sample adaptive offset (SAO) filter, and a deblocking filter applied sequentially on the one or more predicted video samples.

11. The method of claim 10, wherein applying the combined inverse DRA and loop filter function comprises:
applying a combination of one or more parameters of the inverse DRA with one or more parameters of one of the bilateral filter, the adaptive loop filter (ALF), the sample adaptive offset (SAO) filter, or the deblocking filter.

12. The method of claim 1, further comprising outputting the one or more reconstructed video samples.

13. The method of claim 12, wherein outputting the one or more reconstructed video samples comprises storing a decoded version of the picture including the one or more reconstructed video samples in a decoded picture buffer.

14. The method of claim 12, wherein the method of processing the video data is performed as part of a video decoding process.

15. The method of claim 12, wherein the method of processing the video data is performed as part of a decoding loop of a video encoding process, and wherein outputting the one or more reconstructed video samples includes storing a decoded version of the picture including the one or more reconstructed video samples as a reference picture for use in encoding at least one other picture of the video data.

16. The method of claim 12, wherein outputting the one or more reconstructed video samples includes outputting a decoded version of the picture including the one or more reconstructed video samples to a display device.

17. The method of claim 1, wherein the inverse DRA maps altered codewords of the one or more predicted video samples to the one or more reconstructed video samples, wherein the altered codewords are generated by a DRA applied to codewords of video data for reshaping the video data.

18. The method of claim 1, wherein the prediction mode includes an inter-prediction mode or an intra-prediction mode.

19. An apparatus for processing video data, the apparatus comprising:
a memory; and
a processor implemented in circuitry and configured to:
receive encoded video data including a plurality of pictures;
predict one or more predicted video samples for a picture of the plurality of pictures based on application of a prediction mode to the picture;
apply a combined inverse dynamic range adjustment (DRA) and loop filter function to the one or more predicted video samples using a combination of one or more parameters of an inverse DRA with one or more parameters of a loop filter to generate one or more reconstructed samples for the picture; and
generate the one or more reconstructed samples for the picture based on the application of the combined inverse DRA and loop filter function to the one or more predicted video samples using the combination of one or more parameters of the inverse DRA with the one or more parameters of the loop filter.

20. The apparatus of claim 19, wherein:
the one or more parameters of the inverse DRA comprise one or more inverse DRA scale values and one or more inverse DRA offset values;
the one or more parameters of the loop filter comprise one or more loop filter scale values and one or more loop filter offset values; and
the combination of the one or more parameters of the inverse DRA with the one or more parameters of the loop filter comprises a combination of the one or more inverse DRA scale values with the one or more loop filter scale values, and a combination of the one or more inverse DRA offset values with the one or more loop filter offset values.

21. The apparatus of claim 20, further comprising a lookup table for storing the combination of the one or more parameters of the inverse DRA with the one or more parameters of the loop filter.

22. The apparatus of claim 19, wherein the one or more parameters of the inverse DRA are obtained from an inverse DRA lookup table using the one or more predicted video samples.

23. The apparatus of claim 19, wherein the one or more parameters of the loop filter are obtained from a loop filter lookup table using the one or more predicted video samples.

24. The apparatus of claim 19, wherein the loop filter comprises one or more of a bilateral filter, an adaptive loop filter (ALF), a sample adaptive offset (SAO) filter, and a deblocking filter.

25. The apparatus of claim 19, wherein the loop filter comprises two or more of a bilateral filter, an adaptive loop filter (ALF), a sample adaptive offset (SAO) filter, and a deblocking filter applied sequentially on the one or more predicted video samples.

26. The apparatus of claim 19, wherein applying the combined inverse DRA and loop filter function comprises:
applying a combination of one or more parameters of the inverse DRA with one or more parameters of one of the bilateral filter, the adaptive loop filter (ALF), the sample adaptive offset (SAO) filter, or the deblocking filter.

27. The apparatus of claim 19, wherein the apparatus comprises a video decoder.

28. The apparatus of claim 19, further comprising a display for displaying one or more reconstructed video samples.

29. A non-transitory computer-readable medium having stored thereon instructions that, when executed by one or more processors, cause the one or more processors to:
receive encoded video data including a plurality of pictures;
predict one or more predicted video samples for a picture of the plurality of pictures based on application of a prediction mode to the picture;
apply a combined inverse dynamic range adjustment (DRA) and loop filter function to the one or more predicted video samples using a combination of one or more parameters of an inverse DRA with one or more parameters of a loop filter to generate one or more reconstructed samples for the picture; and
generate the one or more reconstructed samples for the picture based on the application of the combined inverse DRA and loop filter function to the one or more predicted video samples using the combination of one or more parameters of the inverse DRA with the one or more parameters of the loop filter.

30. An apparatus for processing video data, the apparatus comprising:
means for receiving encoded video data including a plurality of pictures;
means for predicting one or more predicted video samples for a picture of the plurality of pictures based on application of a prediction mode to the picture;
means for applying a combined inverse dynamic range adjustment (DRA) and loop filter function to the one or more predicted video samples using a combination of one or more parameters of an inverse DRA with one or more parameters of a loop filter to generate one or more reconstructed samples for the picture; and
means for generating the one or more reconstructed samples for the picture based on the application of the combined inverse DRA and loop filter function to the one or more predicted video samples using the combination of one or more parameters of the inverse DRA with the one or more parameters of the loop filter.
